(19) United States
(12) Patent Application Publication
(10) Pub. No.: US 2017/0346075 A1
(43) Pub. Date: Nov. 30, 2017

(54) SOLID ELECTROLYTE COMPOSITION, ELECTRODE SHEET FOR BATTERY USING THE SAME, ALL SOLID STATE SECONDARY BATTERY, METHOD FOR MANUFACTURING ELECTRODE SHEET FOR BATTERY, AND METHOD FOR MANUFACTURING ALL SOLID STATE SECONDARY BATTERY

(71) Applicant: FUJIFILM Corporation, Tokyo (JP)

(72) Inventors: Tomonori MIMURA, Ashigarakami-gun (JP); Hiroaki MOCHIZUKI, Ashigarakami-gun (JP); Masaomi MAKINO, Ashigarakami-gun (JP); Katsuhiko MEGURO, Ashigarakami-gun (JP)

(73) Assignee: FUJIFILM Corporation, Tokyo (JP)

(21) Appl. No.: 15/680,693

(22) Filed: Aug. 18, 2017

Related U.S. Application Data
(63) Continuation of application No. PCT/JP2016/052823, filed on Jan. 29, 2016.

(30) Foreign Application Priority Data
Feb. 20, 2015 (JP) 2015-031328

(51) Int. Cl. H01M 4/1315; H01M 4/62; H01M 10/0562; H01M 10/052; H01M 10/054; C08F 120/18; C08F 120/06; C08F 120/44

(52) U.S. Cl. CPC H01M 4/1315; H01M 10/052; H01M 4/622; H01M 10/054; H01M 10/0562; C08F 120/06; C08F 120/44; C08F 120/18; H01M 2300/0065

(57) ABSTRACT

Provided are a solid electrolyte composition including an inorganic solid electrolyte, binder particles, and a dispersion medium, in which the inorganic solid electrolyte has a conductivity of ions of metals belonging to Group I or II of the periodic table and includes a sulfur atom, and the binder particles are constituted of a polymer having a macromonomer having a mass average molecular weight of 1,000 or more combined therewith as a side chain component and having at least one group from a group of functional groups (b) below, an electrode sheet for a battery and an all solid state secondary battery which are produced using the solid electrolyte composition, a method for manufacturing an electrode sheet for a battery, and a method for manufacturing an all solid state secondary battery.
group of functional groups (b)
a carboxyl group, a sulfonic acid group, a phosphoric acid group, and a phosphonic acid group.

### CROSS-REFERENCE TO RELATED APPLICATIONS

This application is a Continuation of PCT International Application No. PCT/JP2016/052823 filed on Jan. 29, 2016, which claims priority under 35 U.S.C. §119 (a) to Japanese Patent Application No. JP2015-031328 filed in Japan on Feb. 20, 2015. Each of the above applications is hereby expressly incorporated by reference, in its entirety, into the present application.

### BACKGROUND OF THE INVENTION

### 1. Field of the Invention

The present invention relates to a solid electrolyte composition, an electrode sheet for a battery using the same, an all solid state secondary battery, a method for manufacturing an electrode sheet for a battery, and a method for manufacturing an all solid state secondary battery.

### 2. Description of the Related Art

For lithium ion batteries, electrolytic solutions are being used. Attempts are underway to produce all solid state secondary batteries in which all constituent materials are solid by replacing electrolytic solutions with solid electrolytes. Reliability is an advantage of techniques of using inorganic solid electrolytes. To electrolytic solutions being used for lithium ion secondary batteries, flammable materials such as carbonate-based solvents are applied as the media. In spite of the employment of a variety of safety measures, there may be a concern that disadvantages may be caused during overcharging and the like, and there is a demand for additional efforts. All solid state secondary batteries in which non-flammable electrolytes can be used are considered as a fundamental solution thereof.

Another advantage of all solid state secondary batteries is the suitability for increasing energy density by means of the stacking of electrodes. Specifically, it is possible to produce batteries having a structure in which electrodes and electrolytes are directly arranged in series. At this time, metal packages sealing battery cells and copper wires or bus-bars connecting battery cells may not be provided, and thus the energy density of batteries can be significantly increased. In addition, favorable compatibility with positive electrode materials capable of increasing potentials and the like can be considered as advantages.

From the viewpoint of the respective advantages described above, active development of next-generation lithium ion secondary batteries is underway (New Energy and Industrial Technology Development Organization (NEDO), Fuel Cell and Hydrogen Technologies Development Department, Electricity Storage Technology Development Section, “NEDO 2013 Roadmap for the Development of Next Generation Automotive Battery Technology” (August, 2013)). Among these, sulfides such as Li₂S—P₂S₅ exhibit a high ion conductivity, and are widely applied as solid electrolyte materials. Meanwhile, interfaces are generated among solid particles and between solid particles and collectors, and it is difficult to avoid increases of interface resistances. In order to improve interface resistances, there are cases in which binders made of a high-molecular-weight compound are used.

JP2013-008611A discloses an example in which polyoxyethylene lauryl ether is applied to acrylic resins as an emulsifier. JP2012-099315A discloses an example in which polytetrafluoroethylene is used as a binder. JP2012-178256A discloses an example in which hydrogenated butadiene rubber or fluorine-based resins are used.

### SUMMARY OF THE INVENTION

The binders disclosed in JP2013-008611A, JP2012-099315A, and JP2012-178256A are not yet enough to cope with the need for additional performance improvement, and additional improvement is desired.

Therefore, an object of the present invention is to provide a solid electrolyte composition capable of suppressing an increase in interface resistance between solid particles, between solid particles and collectors, and the like and capable of realizing favorable bonding properties in all solid state secondary batteries, an electrode sheet for a battery using the same, an all solid state secondary battery, a method for manufacturing an electrode sheet for a battery, and a method for manufacturing an all solid state secondary battery. Furthermore, an object of the present invention is to provide a solid electrolyte composition capable of improving the cycle characteristics of secondary batteries as necessary, an electrode sheet for a battery using the same, an all solid state secondary battery, a method for manufacturing an electrode sheet for a battery, and a method for manufacturing an all solid state secondary battery.

The above-described objects are achieved by the following means.

[1] A solid electrolyte composition comprising: an inorganic solid electrolyte; binder particles; and a dispersion medium, in which the inorganic solid electrolyte has a conductivity of ions of metals belonging to Group I or II of the periodic table and includes a sulfur atom, and the binder particles are constituted of a polymer having a macromonomer having a mass average molecular weight of 1,000 or more combined therewith as a side chain component and having at least one group from a group of functional groups (b) below.

Group of functional groups (b) a carboxyl group, a sulfonic acid group, a phosphoric acid group, and a phosphonic acid group.

[2] The solid electrolyte composition according to [1], in which a polymer constituting the binder particles has a carboxyl group.

[3] The solid electrolyte composition according to [1] or [2], in which the polymer constituting the binder particles is a carboxyl group-containing polymer, and the carboxyl group-containing polymer contains 0.1% to 10% by mass of a repeating unit having a carboxyl group.

[4] The solid electrolyte composition according to any one of [1] to [3], in which the polymer constituting the binder particles includes a repeating unit derived from a monomer selected from (meth)acrylic acid monomers, (meth)acrylic acid ester monomers, and (meth)acrylonitrile.

[5] The solid electrolyte composition according to any one of [1] to [4], in which an average particle diameter of the binder particles is 10 nm or more and 1,000 nm or less.

[6] The solid electrolyte composition according to any one of [1] to [5], in which the average particle diameter of the binder particles is 300 nm or less.

[7] The solid electrolyte composition according to any one of [1] to [6], in which a proportion of a repeating unit derived from the macromonomer in the polymer constituting the binder particles is 1% by mass or more and 50% by mass or less.

[8] The solid electrolyte composition according to any one of [1] to [7], in which the inorganic solid electrolyte is represented by Formula (1).

LₐM_{b}P_{c}S_{d}Aₑ Formula (1)

In the formula, L represents an element selected from Li, Na, and K. M represents an element selected from B, Zn, Sn, Si, Cu, Ga, Sb, Al, and Ge. A represents I, Br, Cl, or F. a to e represent compositional ratios of individual elements, and a:b:c:d:e satisfies 1 to 12:0 to 1:1:2 to 12:0 to 5.

[9] The solid electrolyte composition according to [8], in which L in the inorganic solid electrolyte is Li.

[10] The solid electrolyte composition according to any one of [1] to [9], in which an SP value of the macromonomer is 10 or less.

[11] The solid electrolyte composition according to any one of [1] to [10], in which a glass transition temperature of the polymer constituting the binder particles is 130° C. or lower.

[12] The solid electrolyte composition according to any one of [1] to [11], in which the inorganic solid electrolyte is represented by Formula (2),

LiₗPₘSₙ Formula (2)

in the formula, 1 to n represent compositional ratios of individual elements, and l:m:n satisfies 2 to 4:1:3 to 10.

[13] The solid electrolyte composition according to any one of [1] to [12], in which the macromonomer includes a polymerizable double bond and a hydrocarbon structural unit having 6 or more carbon atoms.

[14] The solid electrolyte composition according to any one of [1] to [13], in which the macromonomer is a compound represented by any one of Formulae (N-1) to (N-3).

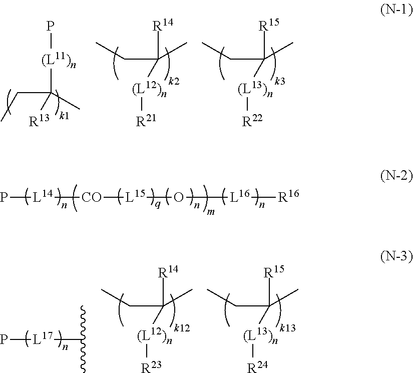

P represents a polymerizable group. L¹¹ to L¹⁷ each independently represent a linking group. k1, k2, k3, k12, and k13 represent the molar fractions. m represents an integer of 1 to 200. n represents 0 or 1. R¹³ to R¹⁵, R²¹, and R²³ each independently represent a polymerizable group, a hydrogen atom, a hydroxyl group, a cyano group, a halogen atom, a carboxyl group, an alkyl group, an alkenyl group, an alkynyl group, or an aryl group. R¹⁶ represents a hydrogen atom or a substituent. q represents 0 or 1. R²² and R²⁴ represent chain-like structural portions having a higher molecular weight than R²¹.

[15] The solid electrolyte composition according to any one of [1] to [14], further comprising: an active material capable of intercalating and deintercalating ions of metals belonging to Group I or II of the periodic table.

[16] The solid electrolyte composition according to any one of [1] to [15], in which a content of the binder particles is 0.1 parts by mass or more and 20 parts by mass or less with respect to 100 parts by mass of the inorganic solid electrolyte.

[17] The solid electrolyte composition according to any one of [1] to [16], in which the dispersion medium is selected from an alcohol compound solvent, an ether compound solvent, an amide compound solvent, a ketone compound solvent, an aromatic compound solvent, an aliphatic compound solvent, and a nitrile compound solvent.

[18] An electrode sheet for a battery, in which a film of the solid electrolyte composition according to any one of [1] to [17] is formed on a metal foil.

[19] An all solid state secondary battery comprising: a positive electrode active material layer; a negative electrode active material layer; and a solid electrolyte layer, in which at least one of the positive electrode active material layer, the negative electrode active material layer, or the solid electrolyte layer is a layer constituted of the solid electrolyte composition according to any one of [1] to [17].

[20] A method for manufacturing an electrode sheet for a battery, comprising: disposing the solid electrolyte composition according to any one of [1] to [17] on a metal foil; and producing a film of the solid electrolyte composition.

[21] A method for manufacturing an all solid state secondary battery, in which an all solid state secondary battery is manufactured using the manufacturing method according to [20].

In the present specification, when a plurality of substituents or linking groups represented by specific symbols are present or a plurality of substituents or the like are simultaneously or selectively determined (similarly, the number of substituents is determined), the respective substituents and the like may be identical to or different from each other. In addition, when coming close to each other, a plurality of substituents or the like may be bonded or condensed to each other and form a ring.

In addition, regarding “(meth)” used to express (meth)acryloyl groups, (meth)acryl groups, or resins, for example, (meth)acryloyl groups are collective terms of acryloyl groups and methacryloyl groups and may be any one or both thereof.

Since “(poly)” may be considered as “poly” or “mono”, a (poly)ester bond may be a single ester bond or a plurality of ester bonds.

In the present specification, regarding the determination of substituents, there are cases in which broader-concept groups and narrower-concept groups, for example, an alkyl group and a carboxyalkyl group or an alkyl group and an aralkyl group are listed. In this case, for example, in the relationship between “a carboxyalkyl group” and “an alkyl group”, “the alkyl group” refers not to an unsubstituted alkyl group but to an alkyl group which may be substituted with a substituent other than “a carboxyl group”. That is, among “alkyl groups”, attention is paid particularly to “a carboxyalkyl group”.

The solid electrolyte composition of the present invention exhibits excellent effects of being capable of suppressing an increase in interface resistance between solid particles, between solid particles and collectors, and the like when used as materials for solid electrolyte layers or active material layers in all solid state secondary batteries and, furthermore, being capable of realizing favorable bonding properties. Furthermore, according to the solid electrolyte composition of the present invention, it is also possible to improve cycle characteristics in all solid state secondary batteries as necessary. Furthermore, the electrode sheet for a battery and the all solid state secondary battery of the present invention are produced using the solid electrolyte composition and exhibit the excellent performance. Furthermore, according to the manufacturing method of the present invention, it is possible to preferably manufacture the electrode sheet for a battery and the all solid state secondary battery of the present invention.

The above-described and other characteristics and advantages of the present invention will be further clarified by the following description with appropriate reference to the accompanying drawings.

### BRIEF DESCRIPTION OF THE DRAWINGS

FIG. 1 is a schematic cross-sectional view illustrating an all solid state lithium ion secondary battery according to a preferred embodiment of the present invention.

FIG. 2 is a side cross-sectional view schematically illustrating a testing device used in examples.

FIG. 3 is a side view schematically illustrating an aspect of a bonding properties test.

### DESCRIPTION OF THE PREFERRED EMBODIMENTS

A solid electrolyte composition of the present invention includes a specific inorganic solid electrolyte, binder particles constituted of a specific polymer, and a dispersion medium. Hereinafter, a preferred embodiment thereof will be described, and, first, an example of an all solid state secondary battery which is a preferred application aspect thereof will be described.

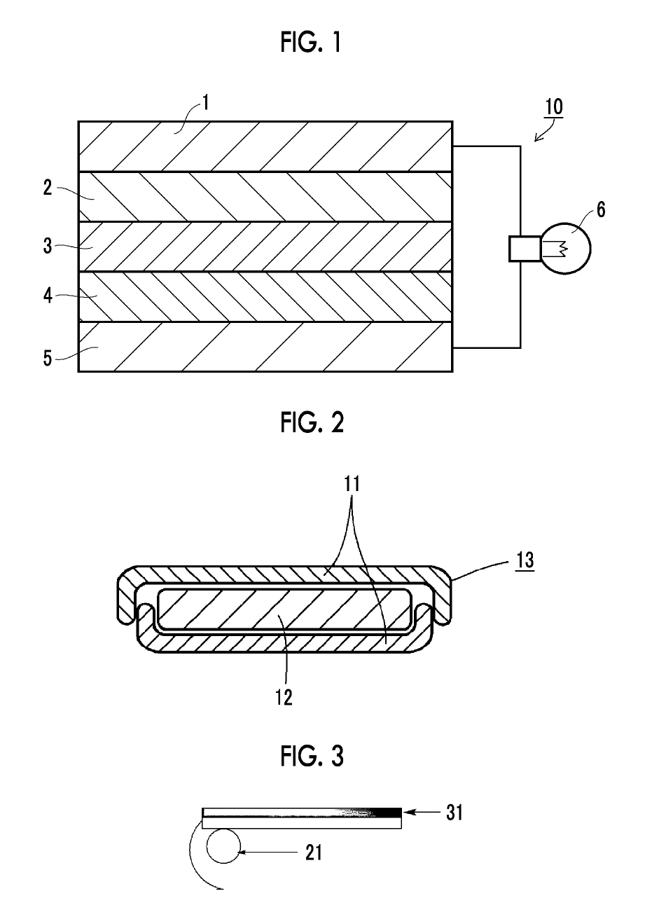

FIG. 1 is a schematic cross-sectional view illustrating an all solid state secondary battery (lithium ion secondary battery) according to a preferred embodiment of the present invention. When seen from the negative electrode side, an all solid state secondary battery 10 of the present embodiment has a negative electrode collector 1, a negative electrode active material layer 2, a solid electrolyte layer 3, a positive electrode active material layer 4, and a positive electrode collector 5 in this order. The respective layers have a structure in which the layers are in contact with each other and laminated together. When the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode side, and electrons are supplied to an operation portion 6. In an example illustrated in the drawing, an electric bulb is employed as the operation portion 6 and is lighted by discharging. A solid electrolyte composition of the present invention is preferably used as a constituent material of the negative electrode active material layer, the positive electrode active material layer, and the solid electrolyte layer and, among these, is preferably used as a constituent material of all of the solid electrolyte layer, the positive electrode active material layer, and the negative electrode active material layer.

The thicknesses of the positive electrode active material layer 4, the solid electrolyte layer 3, and the negative electrode active material layer 2 are not particularly limited, but the thicknesses of the positive electrode active material layer and the negative electrode active material layer can be arbitrarily determined depending on intended battery applications. Meanwhile, the solid electrolyte layer is desirably as thin as possible while preventing short-circuiting between positive and negative electrodes. Specifically, the thickness thereof is preferably 1 to 1,000 m and more preferably 3 to 400 μm.

Meanwhile, functional layers, member, or the like may be appropriately interposed or disposed between or outside the respective layers of the negative electrode collector 1, the negative electrode active material layer 2, the solid electrolyte layer 3, the positive electrode active material layer 4, and the positive electrode collector 5. In addition, the respective layers may be constituted of a single layer or multiple layers.

<Solid Electrolyte Composition>

(Inorganic Solid Electrolyte)

The inorganic solid electrolyte refers to an inorganic solid electrolyte, and the solid electrolyte refers to a solid-form electrolyte capable of migrating ions therein. From this viewpoint, there are cases in which the inorganic solid electrolyte will be referred to as the ion-conductive inorganic solid electrolyte in consideration of distinction from electrolyte salts described below (supporting electrolytes).

The inorganic solid electrolyte does not include organic substances as principal ion-conductive materials and is thus clearly differentiated from organic solid electrolytes (high-molecular electrolytes represented by PEO or the like and organic electrolyte salts represented by LITFSI or the like). In addition, the inorganic solid electrolyte is solid in a steady state and is thus, generally, not dissociated or liberated into cations and anions. Therefore, the inorganic solid electrolyte is also clearly differentiated from inorganic electrolyte salts that are disassociated or liberated into cations and anions in electrolytic solutions or polymers (LiPF₆, LiBF₄, LiFSI, LiCl, and the like). The inorganic solid electrolyte is not particularly limited as long as the inorganic solid electrolyte has a conductivity of ions of metals belonging to Group I or II of the periodic table and are generally not electron-conductive.

In the present invention, the inorganic solid electrolyte has a conductivity of ions of metals belonging to Group I or II of the periodic table. As the inorganic solid electrolyte, it is possible to appropriately select and use solid electrolyte materials being applied to this kind of products. In the present invention, the inorganic solid electrolyte is a sulfide-based inorganic solid electrolyte (an electrolyte having an ion conductivity of metals belonging to Group I or II of the periodic table and includes a sulfur atom).

(i) Sulfide-Based Inorganic Solid Electrolyte

The sulfide-based solid electrolyte is preferably a solid electrolyte which contains sulfur (S), has an ion conductivity of metals belonging to Group I or II of the periodic table, and has electron-insulating properties. Examples thereof include lithium ion-conductive inorganic solid electrolytes satisfying a composition represented by Formula (1).

LₐM_{b}P_{c}S_{d}Aₑ Formula (1)

In the formula, L represents an element selected from Li, Na, and K and is preferably Li. M represents an element selected from B, Zn, Sn, Si, Cu, Ga, Sb, Al, and Ge. Among these, B, Sn, Si, Al, and Ge are preferred, and Sn, Al, and Ge are more preferred. A represents I, Br, Cl, or F and is preferably I or Br and more preferably I.

a to e represent the compositional ratios of the respective elements, and a:b:c:d:e satisfies 1 to 12:0 to 1:1:2 to 12:0 to 5. a is, furthermore, preferably 1 to 9 and more preferably 1.5 to 4. b is preferably 0 to 0.5. d is, furthermore, preferably 3 to 7 and more preferably 3.25 to 4.5. e is, furthermore, preferably 0 to 3 and more preferably 0 to 1.

Regarding the compositional ratios of L, M, P, S, and A in Formula (1), it is preferable that b and e are zero, it is more preferable that b is zero, e is zero, and the fractions (a:c:d) of a, c, and d is 1 to 9:1:3 to 7, and it is still more preferable that b is zero, e is zero, and a:c:d is 1.5 to 4:1:3.25 to 4.5. The compositional ratios of the respective elements can be controlled by adjusting the amounts of raw material compounds blended during the manufacturing of the sulfide-based solid electrolyte as described below.

The sulfide-based solid electrolyte may be non-crystalline (glass) or crystallized (made into glass ceramic) or may be only partially crystallized.

The ratio between Li₂S and P₂S₅ in Li—P—S-based glass and Li—P—S-based glass ceramic is preferably 65:35 to 85:15 and more preferably 68:32 to 77:23 in terms of the molar ratio between Li₂S:P₂S₅. When the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. There is no particular upper limit, but 1×10⁻¹ S/cm or less is realistic.

Specific examples of the compound include compounds formed using a raw material composition containing, for example, Li₂S and a sulfide of an element of Groups XIII to XV.

Specific examples thereof include Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, Li₁₀GeP₂S₁₂ and the like. Among these, crystalline and/or amorphous raw material compositions made of Li₂S—P₂S₅, Li₂S—GeS₂—Ga₂S₃, Li₂S—LiI—P₂S₅, Li₂S—SiS₂—P₂S₅, Li₂S—SiS₂—Li₄SiO₄, Li₂S—SiS₂—Li₃PO₄, Li₂S—LiI—Li₂O—P₂S₅, Li₂S—Li₂O—P₂S₅, Li₂S—Li₃PO₄—P₂S₅, Li₂S—GeS₂—P₂S₅, or Li₁₀GeP₂S₁₂ are preferred due to their high lithium ion conductivity.

Examples of a method for synthesizing sulfide solid electrolyte materials using the above-described raw material compositions include an amorphorization method. Examples of the amorphorization method include a mechanical milling method and a melting quenching method, and, among these, the mechanical milling method is preferred. This is because treatments at normal temperature become possible and it is possible to simplify manufacturing steps.

The sulfide solid electrolyte is more preferably a solid electrolyte represented by Formula (2).

LiₗPₘSₙ Formula (2)

In the formula, 1 to n represent the compositional ratios of individual elements, and l:m:n satisfies 2 to 4:1:3 to 10.

The average particle diameter of the inorganic solid electrolyte is not particularly limited, but is preferably 0.01 μm or more and more preferably 0.1 μm or more. The upper limit is preferably 100 μm or less and more preferably 50 μm or less. Meanwhile, the method for measuring the average particle diameter of the inorganic solid electrolyte is based on the method for measuring the average particle diameter of inorganic particles described in the section of examples described below.

When the satisfaction of both of the battery performance and an effect of reducing or maintaining the interface resistance is taken into account, the concentration of the inorganic solid electrolyte in the solid electrolyte composition is preferably 5% by mass or more, more preferably 10% by mass or more, and still more preferably 20% by mass or more with respect to 100% by mass of the solid component. From the same viewpoint, the upper limit is preferably 99.9% by mass or less, more preferably 99.5% by mass or less, and still more preferably 99% by mass or less.

Meanwhile, in the present specification, the solid component refers to a component that does not volatilize or evaporate and thus disappear when dried at 170° C. for six hours, and typically, refers to a component other than dispersion media described below.

The inorganic solid electrolyte may be used singly or two or more inorganic solid electrolytes may also be used in combination.

(Binder Particles)

The polymer constituting the binder particles being used in the present invention (hereinafter, in some cases, referred to as the specific polymer) has a repeating unit derived from a macromonomer having a mass average molecular weight of 1,000 or more combined therewith as a side chain component and contains at least one group from a group of functional groups (b) below. In the present invention, particularly, the binder is considered to effectively interact with the sulfide-based solid electrolyte, improve the affinity to dispersion media by the macromonomer portion, thereby improving the dispersibility of particles thereof, and maintain a favorable dispersion state in dispersion compositions without being precipitated. In addition, the specific polymer contains at least one from the group of functional groups (b) below, thereby improving the interaction with the sulfide-based solid electrolyte and enabling to realize favorable bonding properties.

Group of Functional Groups (b)

A Carboxyl Group, a Sulfonic Acid Group, a Phosphoric Acid Group, and a Phosphonic Acid Group

Main Chain Component

The main chain of the specific polymer is not particularly limited and can be constituted of an ordinary polymer component. Monomers constituting the main chain component are preferably monomers having a polymerizable unsaturated bond, and, for example, vinyl-based monomers or acrylic monomers can be applied. In the present invention, among these, it is preferable to use acrylic monomers as the main chain component. More preferably, monomers selected from (meth)acrylic acid monomers, (meth)acrylic acid ester monomers, (meth)acrylic acid amide monomers, and (meth)acrylonitrile are preferably used as the main chain component. The number of polymerizable groups is not particularly limited, but is preferably 1 to 4.

The specific polymer preferably has a carboxyl group. The carboxyl group may be included in the main chain or in a side chain described below, but is preferably included in the main chain. When specific groups are included in the main chain as described above, the affinity to the sulfide-based solid electrolyte improves, and more favorable bonding properties and ion conductivity can be realized.

The specific polymer preferably contains 0.1% to 10% by mass of a repeating unit including a carboxyl group. When the specific polymer contains a repeating unit including a carboxyl group in the above-described range, it is possible to satisfy both the favorable dispersibility of dispersion compositions and the favorable bonding properties of electrode sheets.

The vinyl-based monomer forming the polymer is preferably a monomer represented by Formula (a-1) or (a-2).

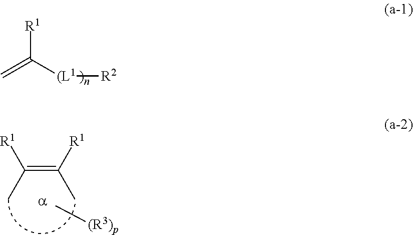

In the formulae, R¹ represents a hydrogen atom, a hydroxyl group, a cyano group, a halogen atom, a carboxyl group, an alkyl group (the number of carbon atoms is preferably 1 to 24, more preferably 1 to 12, and particularly preferably 1 to 6), an alkenyl group (the number of carbon atoms is preferably 2 to 24, more preferably 2 to 12, and particularly preferably 2 to 6), an alkynyl group (the number of carbon atoms is preferably 2 to 24, more preferably 2 to 12, and particularly preferably 2 to 6), or an aryl group (the number of carbon atoms is preferably 6 to 22 and more preferably 6 to 14). Among these, a hydrogen atom or an alkyl group is preferred, and a hydrogen atom or a methyl group is more preferred.

Examples of R² include a hydrogen atom and a substituent T. Among these, examples thereof include a hydrogen atom, an alkyl group (the number of carbon atoms is preferably 1 to 24, more preferably 1 to 12, and particularly preferably 1 to 6), an alkenyl group (the number of carbon atoms is preferably 2 to 12 and more preferably 2 to 6), an aryl group (the number of carbon atoms is preferably 6 to 22 and more preferably 6 to 14), an aralkyl group (the number of carbon atoms is preferably 7 to 23 and more preferably 7 to 15), an alkoxy group (the number of carbon atoms is preferably 1 to 12, more preferably 1 to 6, and particularly preferably 1 to 3), an aryloxy group (the number of carbon atoms is preferably 6 to 22, more preferably 6 to 14, and particularly preferably 6 to 10), an aralkyloxy group (the number of carbon atoms is preferably 7 to 23, more preferably 7 to 15, and particularly preferably 7 to 11), a cyano group, a carboxyl group, a hydroxyl group, a mercapto group, a sulfonic acid group, a phosphoric acid group, a phosphonic acid group, an aliphatic heterocyclic group containing an oxygen atom (the number of ring members is preferably 3 to 6, and the number of carbon atoms is preferably 2 to 12, and more preferably 2 to 6), a (meth)acryloyl group, or an amino group (NR^{N}₂:R^{N} is preferably a hydrogen atom or an alkyl group having 1 to 3 carbon atoms according to the definition described below). Among these, a methyl group, an ethyl group, a propyl group, a butyl group, a cyano group, an ethenyl group, a phenyl group, a carboxyl group, a mercapto group, a sulfonic acid group, and the like are preferred.

When R² is a group capable of having a substituent (for example, an alkyl group, an alkenyl group, an aryl group, or the like), R² may further have the substituent T described below. Among these, R² may have a carboxyl group, a halogen atom (a fluorine atom or the like), a hydroxyl group, a (meth)acryloyl group, a (meth)acryloyloxy group, a (meth)acryloyloxyalkyl group, an alkyl group, an alkenyl group (a vinyl group or an allyl group), or the like as a substituent. When the alkyl group is a group having a substituent, examples thereof include halogenated (preferably fluorinated) alkyl groups and (meth)acryloyloxyalkyl group. When the aryl group is a group having a substituent, examples thereof include a carboxyaryl group, a hydroxyaryl group, and halogenated (preferably brominated) aryl groups.

When R² is an acidic group such as a carboxyl group, a sulfonic acid group, a phosphoric acid group, or a phosphonic acid group, R² may be a salt or ester of the acidic group. Examples of esterified portions include groups in which an alkyl group having 1 to 6 carbon atoms or an alkyl group having 1 to 6 carbon atoms is substituted with a (meth)acryloyloxy group.

The aliphatic heterocyclic group containing an oxygen atom is preferably an epoxy group-containing group, an oxetane group (oxetanyl group)-containing group, a tetrahydrofuryl group-containing group, or the like.

L¹ is an arbitrary linking group, and examples thereof include linking groups L described below. Among these, specific examples thereof include an alkylene group (the number of carbon atoms is preferably 1 to 24, more preferably 1 to 12, and particularly preferably 1 to 6), an alkenylene group (the number of carbon atoms is preferably 2 to 22, more preferably 2 to 14, and particularly preferably 2 to 10), an arylene group (the number of carbon atoms is preferably 6 to 22, more preferably 6 to 14, and particularly preferably 6 to 10), an oxygen atom, a sulfur atom, an imino group (NR^{N}), a carbonyl group, a phosphoric acid linking group (—O—P(OH)(O)—O—), a phosphonic acid linking group (—P(OH)(O)—O—), a (poly)alkyleneoxy group, a (poly)ester bond, a (poly)amide bond, or a group formed of a combination thereof.

Here, the (poly)ester bond may bond a carbon atom in a carbonyl group (C═O) of —C(═O)—O— of the ester bond or may bond an oxygen atom in —O— to a carbon atom to which R¹ is bonded; however, in the present invention, the (poly)ester bond preferably bonds a carbon atom in a carbonyl group (C═O) thereto. Similarly, the (poly)amide bond may bond a carbon atom in a carbonyl group (C═O) of —C(═O)—NR^{N}— of the amide bond or may bond a nitrogen atom in —NR^{N}— to a carbon atom to which R¹ is bonded; however, in the present invention, the (poly)amide bond preferably bonds a carbon atom in a carbonyl group (C═O) thereto. Here, R^{N} represents a hydrogen atom or substituent.

The linking group may have an arbitrary substituent. Preferred ranges of the number of linking atoms and the number of atoms constituting the linking group are also the same as described below. Examples of the arbitrary substituent include the substituent T, and examples thereof include an alkyl group, a halogen atom, and the like. The number of combinations of the linking groups (when CO and O are combined to each other, the number of combinations is two) is preferably 1 to 16, more preferably 1 to 8, still more preferably 1 to 6, and particularly preferably 1 to 3.

When L¹ is linked to the double bond in the formula through —CO—O—, it is preferable that the residual portion prior to L¹ becomes a single bond (n=0) or the residual portion prior to L¹ is an alkylene group having 1 to 6 carbon atoms (preferably 1 to 3), an oxygen atom, a (poly)alkyleneoxy group, a (poly)ester bond, or a group formed of a combination thereof. The preferred range of the number of combinations of the linking group is the same as above.

When L¹ is linked to the double bond in the formula through —O— or has neither CO nor O, it is preferable that the residual portion prior to L¹ becomes a single bond (n=0). It is preferable that, among these, L¹ includes a —CO—O— linkage, that is, the binder is constituted of an acrylic high-molecular-weight compound. The copolymerization ratio of an acrylic monomer in the high-molecular-weight compound is preferably 0.1 to 1, more preferably 0.3 to 1, still more preferably 0.5 to 1, and particularly preferably 0.8 to 1 in terms of molar fractions.

n is 0 or 1.

α represents a non-aromatic cyclic structural portion and is preferably a four- to seven-membered ring and more preferably a five- or six-membered ring. α may be a non-aromatic hydrocarbon ring or non-aromatic hetero ring. When α is a non-aromatic hetero ring, examples of a hetero atom or a group thereof include an oxygen atom, a sulfur atom, a carbonyl group, an imino group (NR^{N}), and a nitrogen atom (═N—).

Examples of R³ include the substituent T described below. This R³ may be bonded to the ring structure α with a double bond. Examples thereof include substitution as a carbonyl structure (>C═O) or an imino structure (>C═NR^{N}) in which a carbon atom is accompanied in the ring. When there are a plurality of R³'s, R³'s may be linked to each other and form a ring structure.

Examples of the ring structure α include a cyclohexene ring, a norbornene ring, and a maleimide ring.

p is 0 or more and a natural number that can be substituted or less.

An acrylic monomer forming the polymer is preferably a monomer represented by any one of Formula (b-1) to (b-12).

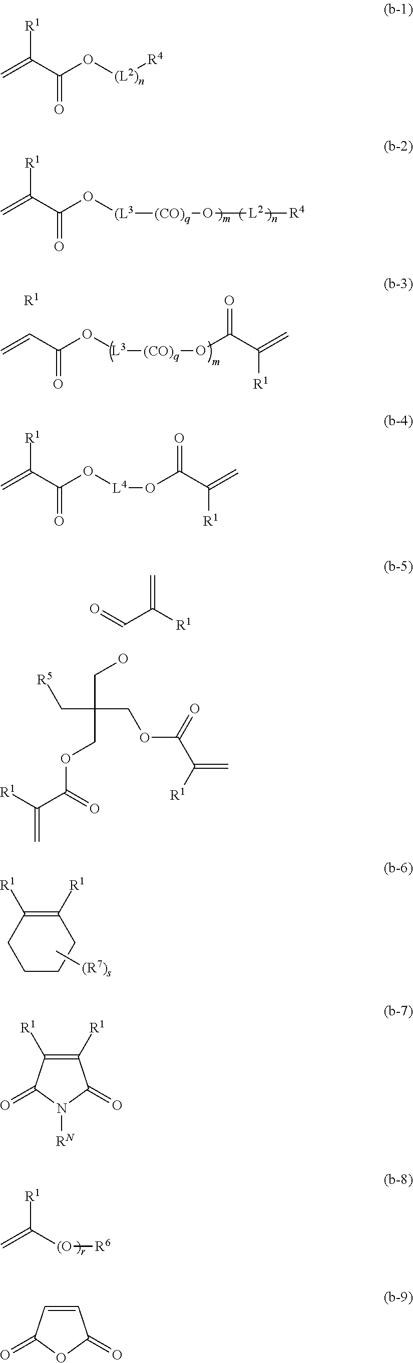

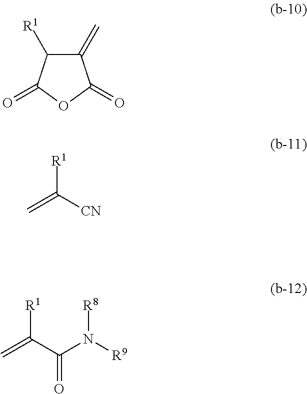

R¹ and n are the same as in Formula (a-1).

R⁴ is the same as R². However, examples of preferred R⁴ include a hydrogen atom, an alkyl group which may have a halogen atom (preferably a fluorine atom), an aryl group which may have a carboxyl group or a halogen atom, a carboxyl group, a mercapto group, a phosphoric acid group, a phosphonic acid group, a sulfonic acid group, an aliphatic heterocyclic group containing an oxygen atom, an amino group (NR^{N}₂), and the like.

L² is an arbitrary linking group, preferably the example of L¹, and more preferably an oxygen atom, an alkylene group (the number of carbon atoms is preferably 1 to 24, more preferably 1 to 12, and particularly preferably 1 to 6), an alkenylene group (the number of carbon atoms is preferably 1 to 24 and more preferably 1 to 12), a carbonyl group, an imino group (NR^{N}), a (poly)alkyleneoxy group, a (poly)ester bond, a group formed of a combination thereof, or the like. The number of combinations of the linking group is preferably 1 to 16, more preferably 1 to 8, still more preferably 1 to 6, and particularly preferably 1 to 3.

L³ is a linking group, preferably the examples of L², and more preferably an alkylene group having 1 to 6 carbon atoms (preferably 1 to 3 carbon atoms).

L⁴ is the same as L¹, and, among these, an alkylene group, a phosphoric acid linking group, a (poly)alkyleneoxy group, a (poly)ester bond, or a combination thereof is preferred. The number of combinations of the linking group is preferably 1 to 16, more preferably 1 to 8, still more preferably 1 to 6, and particularly preferably 1 to 3.

R⁵ is a hydrogen atom, an alkyl group having 1 to 6 carbon atoms (preferably 1 to 3 carbon atoms), a hydroxyl group-containing group having 0 to 6 carbon atoms (preferably 0 to 3 carbon atoms), a carboxyl group-containing group having 0 to 6 carbon atoms (preferably 0 to 3 carbon atoms), or a (meth)acryloyloxy group-containing group. Meanwhile, R⁵ may become the linking group of L¹ (for example, an oxygen atom) and constitute a dimer in this portion.

q is 0 or 1.

m represents an integer of 1 to 200, preferably an integer of 1 to 100, and more preferably an integer of 1 to 50.

R⁶ is any one of a sulfonic acid group, an aryl group, an alkenyl group, a cyano group, an alkyl group, a carboxyl group, and a carboxyalkyl group (the number of carbon atoms is preferably 2 to 13, more preferably 2 to 7, and particularly preferably 2 to 4) which may have a hydroxyl group or an alkenyl group.

r is 0 or 1. In a case in which r is 1, among these, R⁶ is preferably an alkyl group or an aryl group.

R⁷ is the same as R². Among these, a hydrogen atom, an alkyl group, and an aryl group are preferred. R⁷'s may be bonded to each other and form a linking group, and, for example, an alkylene group (the number of carbon atoms is preferably 1 to 12, more preferably 1 to 6, and particularly preferably 1 to 3).

s is an integer of 0 to 8. When there are two or more R⁷'s, R⁷'s may be linked to each other and form a ring structure.

Examples of R⁸ include a hydrogen atom or the substituent T. Among these, a hydrogen atom, alkyl group (the number of carbon atoms is preferably 1 to 24, more preferably 1 to 12, and particularly preferably 1 to 6), an alkenyl group (the number of carbon atoms is preferably 2 to 12 and more preferably 2 to 6), an aryl group (the number of carbon atoms is preferably 6 to 22 and more preferably 6 to 14), or an aralkyl group (the number of carbon atoms is preferably 7 to 23 and more preferably 7 to 15) is preferred. Among these, a hydrogen atom, a methyl group, an ethyl group, a propyl group, a butyl group, or a phenyl group are particularly preferred.

R⁹ is the same as R⁸.

In Formulae (b-1) to (b-12), groups which may have a substituent such as an alkyl group, an aryl group, an alkylene group, or an arylene group may have an arbitrary substituent as long as the effects of the present invention can be maintained. Examples of the arbitrary substituent include the substituent T, and, specifically, the groups may have an arbitrary substituent such as a halogen atom, a hydroxyl group, a carboxyl group, a mercapto group, an acyl group, an acyloxy group, an alkoxy group, an aryloxy group, or an amino group.

Hereinafter, examples of a monomer forming the main chain of the polymer constituting the binder particles will be described, but the present invention is not interpreted to be limited thereto. In formulae below, n, unlike the above-described n, represents 1 to 1,000,000 and is preferably 1 to 10,000 and more preferably 1 to 500.

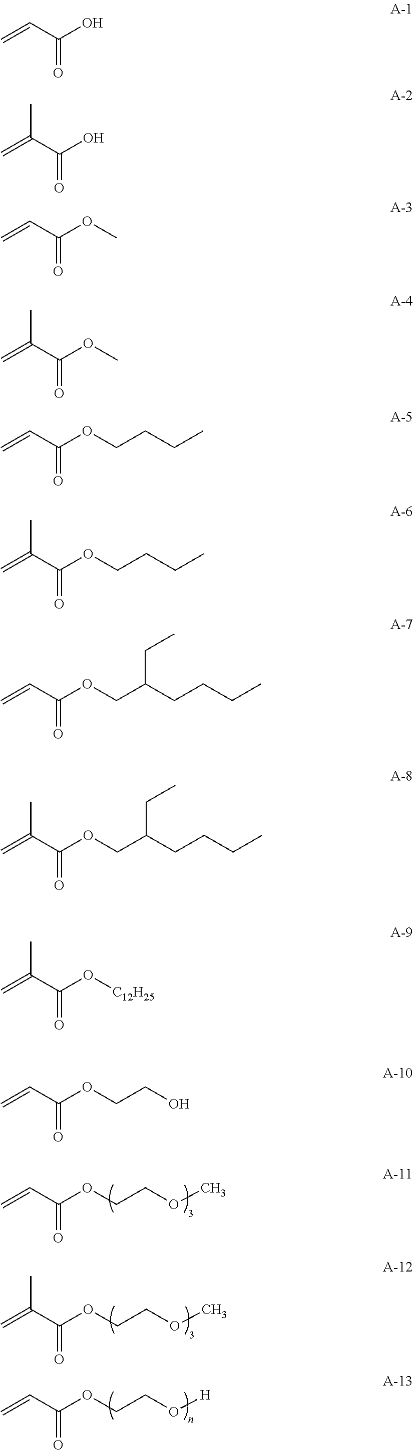

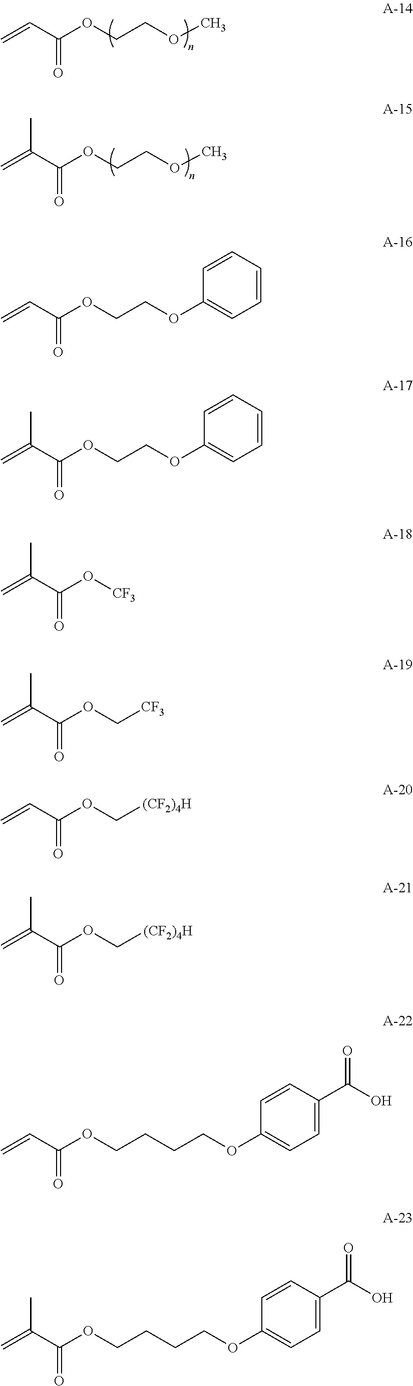

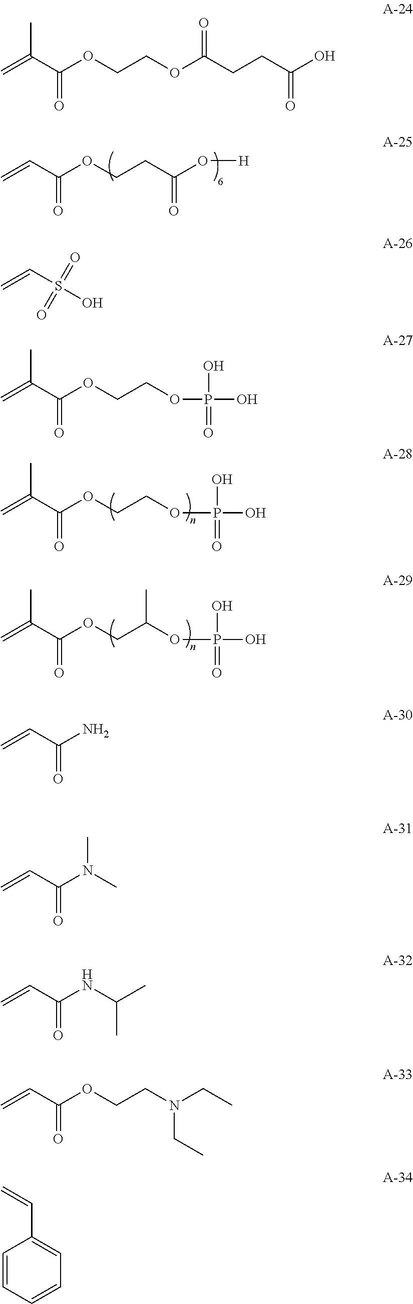

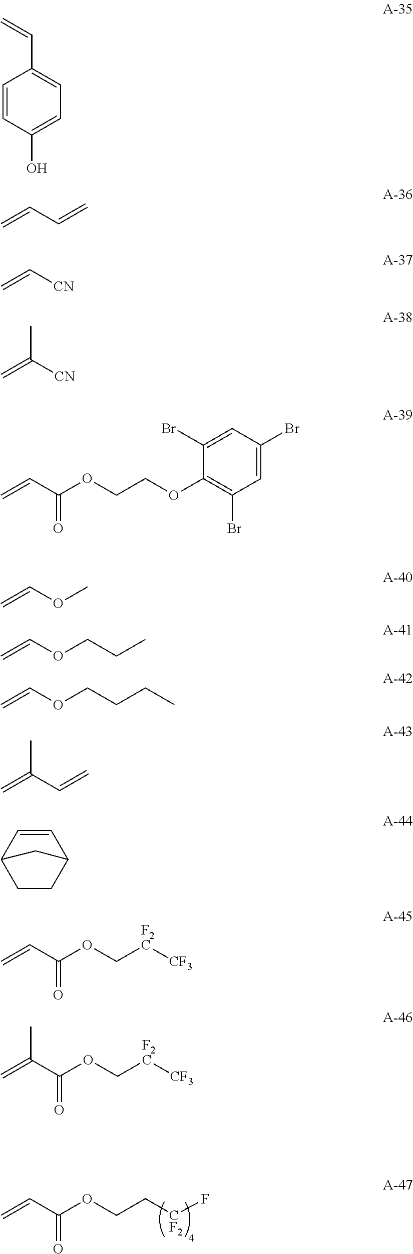

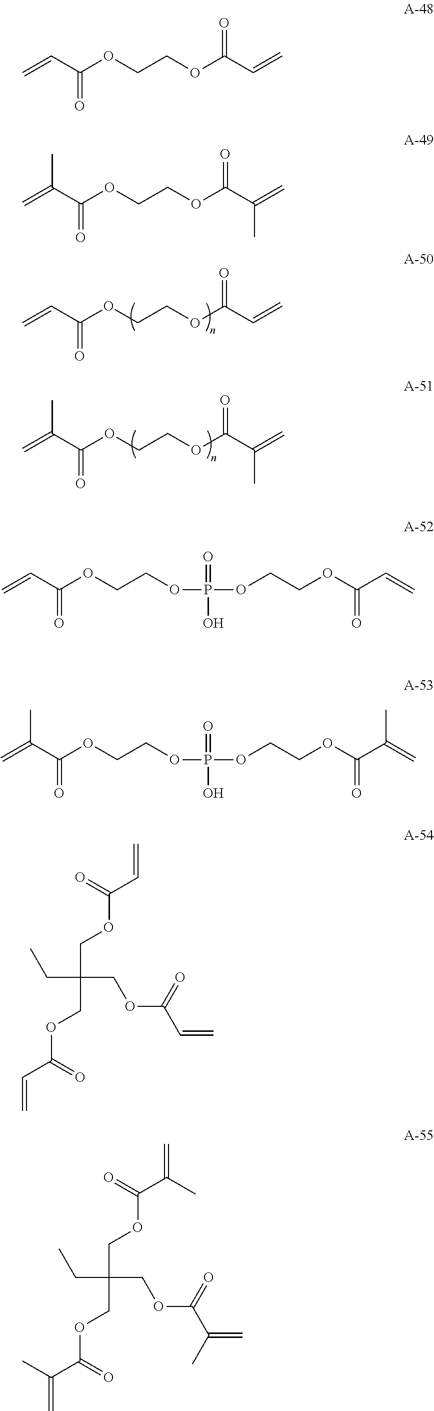

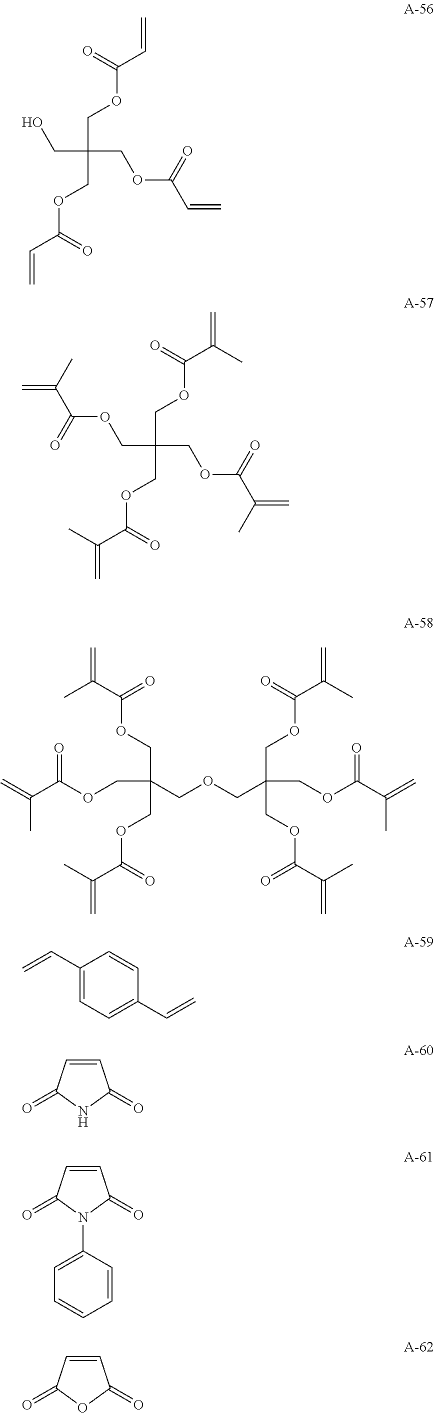

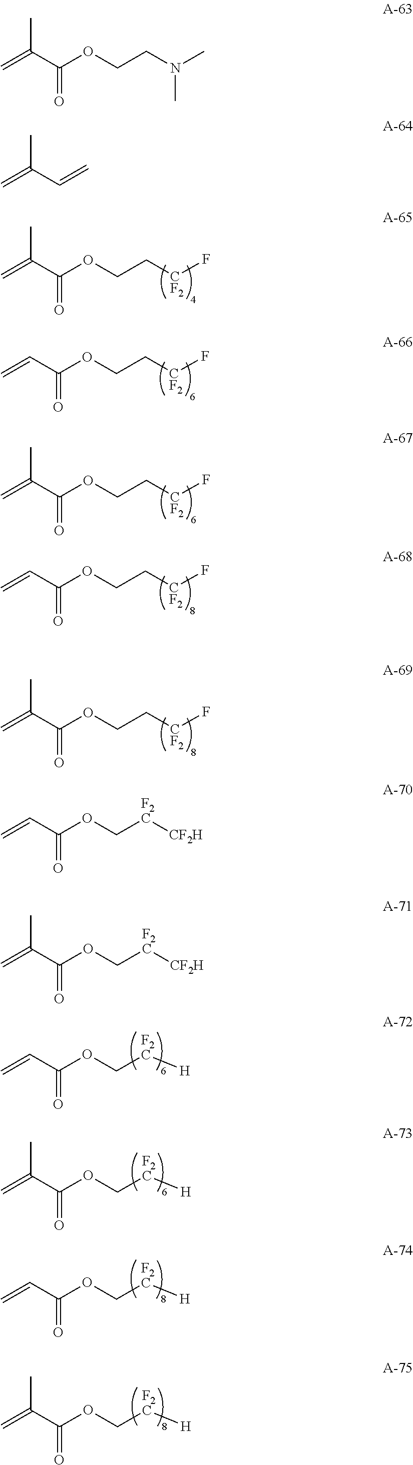

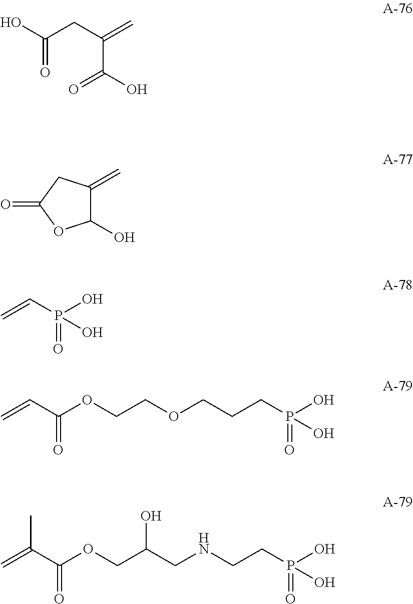

Side Chain Component (Macromonomer (X))

The mass average molecular weight of the macromonomer is 1,000 or more, more preferably 2,000 or more, and particularly preferably 3,000 or more. The upper limit is preferably 500,000 or less, more preferably 100,000 or less, and particularly preferably 30,000 or less.

The side chain component in a binder polymer is considered to have an action of improving dispersibility in solvents. Therefore, the binder is preferably dispersed in solvents, and thus it is possible to uniformly solidify the solid electrolyte without any defects. As a result, conduction paths of ions are uniformly formed, and the binder does not agglomerate, and thus electric connection between the particles is not blocked. Therefore, it is considered that an increase in interface resistance between solid particles, between collectors, and the like is suppressed. Furthermore, when the binder polymer has a side chain, the binder particles are not attached to the solid electrolyte particles, and an effect of twisting the side chains can also be expected. Therefore, it is considered that both of the suppression of interface resistance applied to the solid electrolyte and the improvement of bonding properties can be achieved. Furthermore, the favorable dispersibility enables the elimination of a step of layer transfer in organic solvents compared with in-water emulsification polymerization or the like and the use of a solvent having a low boiling point as a dispersion medium. Meanwhile, the molecular weight of the side chain component (X) can be identified by measuring the molecular weight of a polymerizable compound (macromonomer) being combined when the polymer constituting the binder particles is synthesized.

Measurement of Molecular Weight

Unless particularly otherwise described, the molecular weight of the polymer in the present invention refers to the mass average molecular weight, and the standard polystyrene-equivalent mass average molecular weight is measured by means of gel permeation chromatography (GPC). Regarding the measurement methods, basically, the mass average molecular weight is measured using a method under the following conditions 1 or conditions 2 (preferred). However, depending on the kind of polymers, an appropriate eluent may be appropriately selected and used.

(Conditions 1)

Column: Two columns of TOSOH TSKgel Super AWM-H are connected

Carrier: 10 mM LiBr/N-methylpyrrolidone

Measurement temperature: 40° C.

Carrier flow rate: 1.0 ml/min

Specimen concentration: 0.1% by mass

Detector: RI (refractive index) detector

(Conditions 2) Preferred

Column: A column obtained by connecting TOSOH TSKgel Super HZM-H,
TOSOH TSKgel Super HZ4000, and
TOSOH TSKgel Super HZ2000 is used

Carrier: Tetrahydrofuran

Measurement temperature: 40° C.

Carrier flow rate: 1.0 ml/min

Specimen concentration: 0.1% by mass

Detector: RI (refractive index) detector

The SP value of the macromonomer (X) is preferably 10 or less and more preferably 9.5 or less. The lower limit value is not particularly limited, but is realistically 5 or more.

Definition of SP Value

Unless particularly otherwise described, SP values in the present specification are obtained using a Hoy method (H. L. Hoy Journal of Painting, 1970, Vol. 42, 76-118). In addition, regarding SP values, the unit is not described, but is ‘cal^{1/2} cm^{-3/2}’. Meanwhile, the SP value of the side chain component (X) is almost the same as the SP value of the raw material monomer forming the side chain and may be evaluated using the SP value of the raw material monomer.

The SP value serves as an index indicating the characteristics of dispersion in organic solvents. Here, when the side chain component is provided with a specific molecular weight or more, preferably, the SP value or more, the bonding properties with the solid electrolyte are improved, accordingly, the affinity to solvents is enhanced, and the side chain component can be stably dispersed, which is preferable.

The main chain of the side chain component of the macromonomer (X) is not particularly limited, and an ordinary polymer component can be applied. The macromonomer (X) preferably has a polymerizable group at the terminal and more preferably has a polymerizable group at a single terminal or both terminals. The polymerizable group is preferably a group having a polymerizable unsaturated bond, and examples thereof include a variety of vinyl groups or (meth)acryloyl groups. In the present invention, the macromonomer (X) preferably has, among these, a (meth)acryloyl group.

Meanwhile, “acryl” or “acryloyl” mentioned in the present specification broadly refers not only to acryloyl groups but also to induced structures thereof, and the scope thereof includes structures having a specific substituent at an α position of the acryloyl group. However, in the narrow sense, there are cases in which structures having a hydrogen atom at the α position are referred to as acryl or acryloyl. There are cases in which structures having a methyl group at the c position are referred to as methacryl and structures which are any one of acryl (a hydrogen atom at the α position) or methacryl (a methyl group at the α position) are referred to as (meth)acryl or the like.

The macromonomer (X) preferably includes a repeating unit derived from a monomer selected from (meth)acrylic acid monomers, (meth)acrylic acid ester monomers, and (meth)acrylonitrile. In addition, the macromonomer (X) preferably includes a polymerizable double bond and a hydrocarbon structural unit S having 6 or more carbon atoms (preferably an alkylene group or alkyl group having 6 to 30 carbon atoms and more preferably an alkylene group or alkyl group having 8 to 24 carbon atoms). As described above, when the macromonomer forming the side chain has the hydrocarbon structural unit S, the affinity to solvents enhances, and an action of improving dispersion stability can be expected. The hydrocarbon structural unit S having 6 or more carbon atoms is more preferably a structural unit constituting the side chain than a structural unit constituting the main chain of the macromonomer.

Here, when Macromonomer M-1 is used as an example, the hydrocarbon structural unit S is dodecyl in a structure derived from dodecyl methacrylate.

The macromonomer (X) preferably has a portion represented by Formula (P) as a polymerizable group or a part thereof.

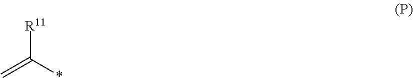

R¹¹ is the same as R¹. * is a bonding portion.

The polymerizable group in the macromonomer (X) is preferably a portion represented by any one of Formulae (P-1) to (P-3). Hereinafter, these portions will be referred to as “specific polymerizable portions” in some cases.

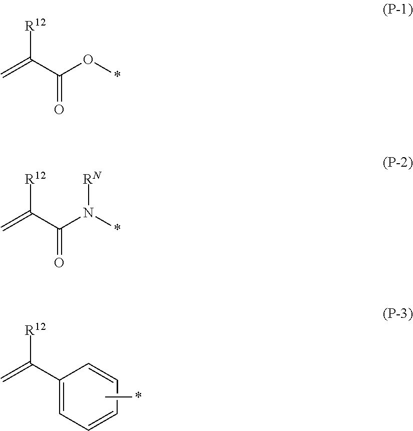

R¹² is the same as R¹. * is a bonding portion. R^{N} represents a hydrogen atom or a substituent, and the substituent is preferably the substituent T described below. The benzene ring in Formula (P-3) may be substituted with an arbitrary substituent T.

The macromonomer (X) is preferably a compound represented by Formulae (N-1) to (N-3).

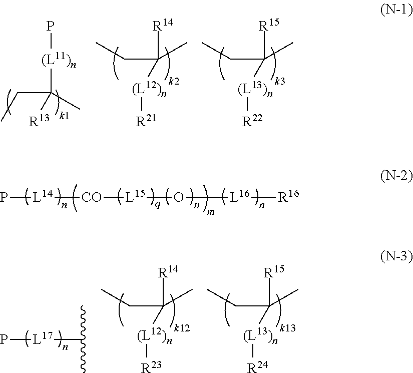

P represents a polymerizable group. L¹¹ to L¹⁷ each independently represent a linking group. k1, k2, k3, k12, and k13 represent the molar fractions. m represents an integer of 1 to 200. n represents 0 or 1. R¹³ to R¹⁵, R²¹, and R²³ each independently represent a polymerizable group, a hydrogen atom, a hydroxyl group, a cyano group, a halogen atom, a carboxyl group, an alkyl group, an alkenyl group, an alkynyl or aryl group. R¹⁶ represents a hydrogen atom or a substituent. q represents 0 or 1. R²² represents a chain-like structural portion having a higher molecular weight than R²¹. R²⁴ represents a hydrogen atom or a substituent.

The polymerizable group as P is preferably Formula (P) or (P-1) to (P-3). L¹¹ to L¹⁷ are preferably linking group L described below and preferably the same as L¹.

In the present specification, the structure on the left end indicated using a wavy line in Formula (N-3) represents at least one terminal structure of the main chain.

L¹¹ is preferably an alkylene group having 1 to 6 carbon atoms (preferably 1 to 3 carbon atoms), an arylene group having 6 to 24 carbon atoms (preferably 6 to 10 carbon atoms), an oxygen atom, a sulfur atom, an imino group (NR^{N}), a carbonyl group, a (poly)alkyleneoxy group, a (poly)ester bond, a (poly)amide bond, or a group formed of a combination thereof. L¹¹ may have the substituent T and may have, for example, a hydroxyl group.

L¹² and L¹³ are preferably an alkylene group having 1 to 6 carbon atoms (preferably 1 to 3 carbon atoms), an arylene group having 6 to 24 carbon atoms (preferably 6 to 10 carbon atoms), an oxygen atom, a sulfur atom, an imino group (NR^{N}), a carbonyl group, a (poly)alkyleneoxy group, a (poly)ester bond, a (poly)amide bond, or a group formed of a combination thereof.

L¹⁴ is preferably an alkylene group having 1 to 24 carbon atoms (preferably 1 to 18 carbon atoms), an arylene group having 6 to 24 carbon atoms (preferably 6 to 10 carbon atoms), an oxygen atom, a sulfur atom, an imino group (NR^{N}), a carbonyl group, a (poly)alkyleneoxy group, a (poly)ester bond, a (poly)amide bond, or a group formed of a combination thereof and particularly preferably a (poly)alkyleneoxy group (x is 1 to 4). At this time, the number of carbon atoms in the alkylene group is preferably 1 to 12, more preferably 1 to 8, and particularly preferably 1 to 6. This alkylene group may have the substituent T and may have, for example, a hydroxyl group.

L¹⁵ is, among these, preferably an alkylene group. L¹⁵ is preferably a relatively long chain, and the number of carbon atoms is preferably 4 to 30, more preferably 6 to 20, and particularly preferably 6 to 16. L¹⁵ may have an arbitrary substituent. Examples of the arbitrary substituent include the substituent T, and, specifically, L¹⁵ may have an arbitrary substituent such as a halogen atom, a hydroxyl group, a carboxyl group, a mercapto group, an acyl group, an acyloxy group, an alkoxy group, an aryloxy group, or an amino group.

L¹⁶ is preferably a single bond (n=0).

L¹⁷ is preferably an alkylene group having 1 to 6 carbon atoms (preferably 1 to 3 carbon atoms), an arylene group having 6 to 24 carbon atoms (preferably 6 to 10 carbon atoms), an oxygen atom, a sulfur atom, an imino group (NR^{N}), a carbonyl group, a (poly)alkyleneoxy group, a (poly)ester bond, a (poly)amide bond, or a group formed of a combination thereof. L¹⁷ may have the substituent T and may have, for example, a hydroxyl group.

n is 0 or 1.

L¹¹ to L¹⁶ are, among these, preferably linking groups having 1 to 60 atoms (preferably 1 to 30 atoms) which are substituted with an oxygen atom, a carbon atom, a hydrogen atom, a sulfur atom or a nitrogen atom. The number of constituent atoms in the linking group is preferably 4 to 40 and more preferably 6 to 24.

k1, k2, and k3 are the molar fractions of individual repeating units in the polymers and k1+k2+k3=1. k1 is preferably 0.001 to 0.3 and more preferably 0.01 to 0.1. k2 is preferably 0 to 0.7 and more preferably 0 to 0.5. k3 is preferably 0.3 to 0.99 and more preferably 0.4 to 0.9.

m represents an integer of 1 to 200 and is preferably an integer of 1 to 100 and more preferably an integer of 1 to 50.

k12 and k13 are the molar fractions of individual repeating units in the polymers and k12+k13=1. k12 is preferably 0 to 0.7 and more preferably 0 to 0.6. k13 is preferably 0.3 to 1 and more preferably 0.4 to 1.

R¹³, R¹⁴, and R¹⁵ are the same groups as R¹ or the polymerizable groups as P. Among these, the groups as R¹ are preferred, and a hydrogen atom, an alkyl group (the number of carbon atoms is preferably 1 to 3), a cyano group are preferred.

R¹⁶ is the same as R². Among these, a hydrogen atom, an alkyl group having 1 to 6 carbon atoms, an aryl group having 6 to 24 carbon atoms (preferably 6 to 10 carbon atoms), a hydroxyl group, and a carboxyl group are preferred.

q is 0 or 1.

R²¹ and R²³ are preferably the same groups as R¹.

R²² is a chain-like structural portion having a higher molecular weight than R²¹ and preferably an alkyl group (the number of carbon atoms is preferably 4 to 60 and more preferably 6 to 36), an alkenyl group (the number of carbon atoms is preferably 4 to 60 and more preferably 6 to 36), an aryl group (the number of carbon atoms is preferably 6 to 60 and more preferably 6 to 36), a halogenated alkyl group (the number of carbon atoms is preferably 4 to 60 and more preferably 6 to 36. The halogen atom is preferably a fluorine atom), a (poly)oxy alkylene group-containing group, a (poly)ester bond-containing group, a (poly)amide bond-containing group, or a (poly)siloxane bond-containing group. Examples of this portion include self-condensates of a hydroxyl group-containing fatty acid, self-condensates of an amino group-containing fatty acid, and the like. At this time, R²² may have the substituent T and may appropriately have a hydroxyl group, an alkoxy group, an acyl group, or the like. The linking group-containing group follows the definition of the linking group L described below. The terminal group thereof is preferably R described below.

R²⁴ is a hydrogen atom or a substituent and is preferably the same group as R². Among these, a hydrogen atom, an alkyl group (the number of carbon atoms is preferably 1 to 24, more preferably 1 to 18, and particularly preferably 1 to 12), an alkenyl group (the number of carbon atoms is preferably 2 to 12 and more preferably 2 to 6), an aryl group (the number of carbon atoms is preferably 6 to 22 and more preferably 6 to 14), and an aralkyl group (the number of carbon atoms is preferably 7 to 23 and more preferably 7 to 15) are preferred. At this time, R²⁴ may have the substituent T and may appropriately have a hydroxyl group, an alkoxy group, an acyl group, or the like. The linking group-containing group follows the definition of the linking group L described below. The terminal group thereof is preferably R^{P} described below.

In other words, the compound represented by Formula (N-2) is preferably a structure in which a polymerizable group is combined into a side chain of a polymer chain.

The compound represented by Formula (N-2) is preferably a structure in which a polymerizable group is introduced into a carboxyl group of a fatty acid which may have a substituent.

The compound represented by Formula (N-3) is preferably a structure in which a polymerizable group is combined into at least one terminal of a polymer.

In the present specification, regarding the expression of compounds (for example, when referred to as “ . . . compound”), these compounds are used to mention not only the compounds but also salts thereof and ions thereof.

In the present specification, substituents which are not clearly expressed as substituted or unsubstituted (which is also true for linking groups) may have an arbitrary substituent in the groups unless particularly otherwise described. This is also true for compounds which are not clearly expressed as substituted or unsubstituted. Examples of preferred substituents include the following substituent T. In addition, in a case in which substituents are simply expressed as “substituent”, the substituent T is referred to.

Examples of the substituent T include the following substituents.

Alkyl groups (preferably alkyl groups having 1 to 20 carbon atoms, for example, methyl, ethyl, isopropyl, t-butyl, pentyl, heptyl, 1-ethylpentyl, benzyl, 2-ethoxyethyl, I-carboxymethyl, and the like), alkenyl groups (preferably alkenyl groups having 2 to 20 carbon atoms, for example, vinyl, allyl, oleyl, and the like), alkynyl groups (preferably alkynyl groups having 2 to 20 carbon atoms, for example, ethynyl, butadiynyl, phenylethynyl, and the like), cycloalkyl groups (preferably cycloalkyl groups having 3 to 20 carbon atoms, for example, cyclopropyl, cyclopentyl, cyclohexyl, 4-methylcyclohexyl, and the like; in the present specification, when simply referred to as alkyl groups, generally, cycloalkyl groups are also included), aryl groups (preferably aryl groups having 6 to 26 carbon atoms, for example, phenyl, 1-naphthyl, 4-methoxyphenyl, 2-chlorophenyl, 3-methylphenyl, and the like), heterocyclic groups (preferably heterocyclic groups having 2 to 20 carbon atoms, preferably heterocyclic groups of a five- or six-membered ring having at least one oxygen atom, sulfur atom, or nitrogen atom in the ring-constituting atom, for example, tetrahydropyranyl, tetrahydrofuranyl, 2-pyridyl, 4-pyridyl, 2-imidazolyl, 2-benzimidazolyl, 2-thiazolyl, 2-oxazolyl, 2-pyridon-6-yl, and the like),

alkoxy groups (preferably alkoxy groups having 1 to 20 carbon atoms, for example, methoxy, ethoxy, isopropyloxy, benzyloxy, and the like), alkenyloxy groups (preferably alkenyloxy groups having 2 to 20 carbon atoms, for example, vinyloxy, allyloxy, oleyloxy, and the like), alkynyloxy groups (preferably alkynyloxy groups having 2 to 20 carbon atoms, for example, ethynyloxy, phenylethynyloxy, and the like), cycloalkyloxy groups (preferably cycloalkyloxy groups having 3 to 20 carbon atoms, for example, cyclopropyloxy, cyclopentyloxy, cyclohexyloxy, 4-methylcyclohexyloxy, and the like), aryloxy groups (preferably aryloxy groups having 6 to 26 carbon atoms, for example, phenoxy, 1-naphthyloxy 3-methylphenoxy, 4-methoxyphenoxy, and the like), alkoxycarbonyl groups (preferably alkoxycarbonyl groups having 2 to 20 carbon atoms, for example, ethoxycarbonyl, 2-ethylhexyloxycarbonyl, and the like), aryloxycarbonyl groups (preferably aryloxycarbonyl groups having 7 to 26 carbon atoms, for example, phenoxycarbonyl, 1-naphthyloxycarbonyl, 3-methylphenoxycarbonyl, 4-methoxyphenoxycarbonyl, and the like), amino groups (preferably amino groups having 0 to 20 carbon atoms, including an alkylamino group, an alkenylamino group, an alkynylamino group, an arylamino group, and a heterocyclic amino group, for example, amino, N,N-dimethylamino, N,N-diethylamino, N-ethylamino, N-allylamino, N-ethynylamino, anilino, 4-pyridylamino, and the like), sulfamoyl groups (preferably sulfamoyl groups having 0 to 20 carbon atoms, for example, N,N-dimethylsulfamoyl, N-phenylsulfamoyl, and the like), acyl groups (including an alkanoyl group, an alkenoyl group, an alkynoyl group, a cycloalkanoyl group, an aryloyl group, and a heterocyclic carbonyl group, preferably acyl groups having 1 to 23 carbon atoms, for example, formyl, acetyl, propionyl, butyryl, pivaloyl, stearoyl, acryloyl, methacryloyl, crotonoyl, oleoyl, propioloyl, cyclopropanoyl, cyclopentanoyl, cyclohexanoyl, benzoyl, nicotinoyl, isonicotinoyl, and the like), acyloxy groups (including an alkanoyloxy group, an alkenoyloxy group, an alkynoyloxy group, a cycloalkanoyloxy group, an aryloyloxy group, and a heterocyclic carbonyloxy group, preferably acyloxy groups having 1 to 23 carbon atoms, for example, formyloxy, acetyloxy, propionyloxy, butyryloxy, pivaloyloxy, stearoyloxy, acryloyloxy, methacryloyloxy, crotonoyloxy, oleoyloxy, propioloyloxy, cyclopropanoyloxy, cyclopentanoyloxy, cyclohexanoyloxy, nicotinoyloxy, isonicotinoyloxy, and the like),

carbamoyl groups (preferably carbamoyl groups having 1 to 20 carbon atoms, for example, N,N-dimethylcarbamoyl, N-phenylcarbamoyl, and the like), acylamino groups (preferably acylamino groups having 1 to 20 carbon atoms, for example, acetylamino, acryloylamino, methacryloylamino, benzoylamino, and the like), sulfonamido groups (including an alkylsulfonamido group and an arylsulfonamido group, preferably sulfonamido groups having 1 to 20 carbon atoms, for example, methanesulfonamido, benzenesulfonamido, and the like), alkylthio groups (preferably alkylthio groups having 1 to 20 carbon atoms, for example, methylthio, ethylthio, isopropylthio, benzylthio, and the like), arylthio groups (preferably arylthio groups having 6 to 26 carbon atoms, for example, phenylthio, 1-naphthylthio, 3-methylphenylthio, 4-methoxyphenylthio, and the like), alkylsulfonyl groups (preferably alkylsulfonyl groups having 1 to 20 carbon atoms, for example, methylsulfonyl, ethylsulfonyl, and the like), arylsulfonyl groups (preferably arylsulfonyl groups having 6 to 22 carbon atoms, for example, benzenesulfonyl and the like), alkylsilyl groups (preferably alkylsilyl groups having 1 to 20 carbon atoms, for example, monomethylsilyl, dimethylsilyl, trimethylsilyl, triethylsilyl, benzyldimethylsilyl, and the like), arylsilyl groups (preferably arylsilyl groups having 6 to 42 carbon atoms, for example, triphenylsilyl, dimethylphenylsilyl, and the like), alkoxysilyl groups (preferably alkoxysilyl groups having 1 to 20 carbon atoms, for example, monomethoxysilyl, dimethoxysilyl, trimethoxysilyl, triethoxysilyl, and the like), aryloxysilyl groups (preferably aryloxysilyl groups having 6 to 42 carbon atoms, for example, triphenyloxysilyl and the like), phosphoryl groups (preferably phosphoryl groups having 0 to 20 carbon atoms, for example, —OP(═O)(R^{P})₂), phosphonyl groups (preferably phosphonyl groups having 0 to 20 carbon atoms, for example, —P(═O)(R^{P})₂), phosphinyl groups (preferably phosphinyl groups having 0 to 20 carbon atoms, for example, —P(R^{P})₂), a hydroxyl group, a mercapto group, a carboxyl group, a phosphoric acid group, a phosphonic acid group, a sulfonic acid group, a cyano group, halogen atoms (for example, a fluorine atom, a chlorine atom, a bromine atom, an iodine atom, and the like).

In addition, in the respective groups exemplified as the substituent T, the substituent T may be further substituted. Examples thereof include aralkyl groups in which an alkyl group is substituted with an aryl group and halogenated alkyl groups in which an alkyl group is substituted with a halogen atom.

In addition, when the substituent is an acid group or a basic group, a salt thereof may be formed.

When the compound, the substituent, the linking group, or the like includes an alkyl group, an alkylene group, an alkenyl group, an alkenylene group, an alkynyl group, an alkylene group, or the like, these may have a cyclic shape or a chain shape, may be linear or branched, and may be substituted as described above or not substituted.

The respective substituents determined in the present specification may be substituted by interposing the following linking group L as long as the effects of the present invention are exhibited or may have the linking group L interposed in the structure. For example, an alkyl group, an alkylene group, an alkenyl group, an alkenylene group, or the like may further have the following linking group including a hetero atom in the structure.

The linking group L is preferably a linking group made of hydrocarbon [an alkylene group having 1 to 10 carbon atoms (the number of carbon atoms is more preferably 1 to 6 and still more preferably 1 to 3), an alkenylene group having 2 to 10 carbon atoms (the number of carbon atoms is more preferably 2 to 6 and still more preferably 2 to 4), an alkynylene group having 2 to 10 carbon atoms (the number of carbon atoms is more preferably 2 to 6 and still more preferably 2 to 4), an arylene group having 6 to 22 carbon atoms (the number of carbon atoms is more preferably 6 to 10), or a combination thereto], a linking group having a hetero atom [a carbonyl group (—CO—), a thiocarbonyl group (—CS—), an ether bond (—O—), a thioether bond (—S—), an imino group (—NR^{N}— or ═NR^{N}), an ammonium linking group (—NR^{N}₂⁺—), a polysulfide group (the number of links of an S atom is preferably 2 to 8), a linking group in which a carbon atom is substituted with an imino bond (R^{N}—N═C< or —N═C(R^{N})—), a sulfonyl group (—SO₂—), a sulfinyl group (—SO—), a phosphoric acid linking group (—O—P(OH)(O)—O—), a phosphonic acid linking group (—P(OH)(O)—O—), or a combination thereof], or a linking group obtained by combining these linking groups. Meanwhile, in a case in which substituents or linking groups are condensed together and thus form a ring, the hydrocarbon linking group may approximately form a double bond or a triple bond and link the groups. Rings being formed are preferably five-membered rings or six-membered rings. The five-membered rings are preferably nitrogen-containing five-membered rings, and examples thereof include a pyrrole ring, an imidazole ring, a pyrazole ring, an indazole ring, an indole ring, a benzimidazole ring, a pyrrolidine ring, an imidazolidine ring, a pyrazolidine ring, an indoline ring, a carbazole ring, and the like. Examples of the six-membered rings include a piperidine ring, a morpholine ring, a piperazine ring, and the like.

Meanwhile, when an aryl ring, a hetero ring, or the like is included, these rings may be a single ring or a condensed ring and may be, similarly, substituted or not substituted.

Here, R^{N} represents a hydrogen atom or a substituent. Examples of the substituent include the substituent T, and an alkyl group (the number of carbon atoms is preferably 1 to 24, more preferably 1 to 12, still more preferably 1 to 6, and particularly preferably 1 to 3), an alkenyl group (the number of carbon atoms is preferably 2 to 24, more preferably 2 to 12, still more preferably 2 to 6, and particularly preferably 2 and 3), an alkynyl group (the number of carbon atoms is preferably 2 to 24, more preferably 2 to 12, still more preferably 2 to 6, and particularly preferably 2 and 3), an aralkyl group (the number of carbon atoms is preferably 7 to 22, more preferably 7 to 14, and particularly preferably 7 to 10), and an aryl group (the number of carbon atoms is preferably 6 to 22, more preferably 6 to 14, and particularly preferably 6 to 10) are preferred.

R^{P} represents a hydrogen atom, a hydroxyl group, or a substituent other than a hydroxyl group. Examples of the substituent include the above-described substituent T, and an alkyl group (the number of carbon atoms is preferably 1 to 24, more preferably 1 to 12, still more preferably 1 to 6, and particularly preferably 1 to 3), an alkenyl group (the number of carbon atoms is preferably 2 to 24, more preferably 2 to 12, still more preferably 2 to 6, and particularly preferably 2 and 3), an alkynyl group (the number of carbon atoms is preferably 2 to 24, more preferably 2 to 12, still more preferably 2 to 6, and particularly preferably 2 and 3), an aralkyl group (the number of carbon atoms is preferably 7 to 22, more preferably 7 to 14, and particularly preferably 7 to 10), an aryl group (the number of carbon atoms is preferably 6 to 22, more preferably 6 to 14, and particularly preferably 6 to 10), an alkoxy group (the number of carbon atoms is preferably 1 to 24, more preferably 1 to 12, still more preferably 1 to 6, and particularly preferably 1 to 3), an alkenyloxy group (the number of carbon atoms is preferably 2 to 24, more preferably 2 to 12, still more preferably 2 to 6, and particularly preferably 2 and 3), an alkynyloxy group (the number of carbon atoms is preferably 2 to 24, more preferably 2 to 12, still more preferably 2 to 6, and particularly preferably 2 and 3), an aralkyloxy group (the number of carbon atoms is preferably 7 to 22, more preferably 7 to 14, and particularly preferably 7 to 10), and an aryloxy group (the number of carbon atoms is preferably 6 to 22, more preferably 6 to 14, and particularly preferably 6 to 10) are preferred.

The number of atoms constituting the linking group L is preferably 1 to 36, more preferably 1 to 24, still more preferably 1 to 12, and particularly preferably 1 to 6. The number of linking atoms in the linking group is preferably 10 or less and more preferably 8 or less. The lower limit is 1 or more.

Meanwhile, the number of atoms constituting the linking group L (the number of linking atoms) refers to the minimum number of atoms which are located in paths connecting the predetermined structural portions and participate in the linkage. For example, in the case of —CH₂—C(═O)—O—, the number of atoms constituting the linking group is six, but the number of linking atoms is three.

Specific examples of combinations of the linking groups include the following combinations: an oxycarbonyl bond (—OCO—), a carbonate bond (—OCOO—), an amide bond (—CONR^{N}—), an urethane bond (—NR^{N}COO—), a urea bond (—NR^{N}CONR^{N}—), a (poly)alkyleneoxy bond (—(Lr—O)x-), a carbonyl (poly)oxyalkylene bond (—CO—(O—Lr)x-), a carbonyl (poly)alkyleneoxy bond (—CO—(Lr—O)x-), a carbonyloxy (poly)alkyleneoxy bond (—COO—(Lr—O)x-), a (poly)alkyleneimino bond (—(Lr—NR^{N})x), an alkylene (poly)iminoalkylene bond (—Lr—(NR^{N}—Lr)x-), a carbonyl (poly)iminoalkylene group (—CO—(NR^{N}—Lr)x-), a carbonyl (poly)alkyleneimino bond (—CO—(Lr—NR^{N})x-), a (poly)ester bond (—(CO—O—Lr)x-, —(O—CO—Lr)x-, —(O—Lr—CO)x-, —(Lr—CO—O)x-, —(Lr—O—CO)x-), a (poly)amide bond (—(CO—NR^{N}—Lr)x-, —(NR^{N}—CO—Lr)x-, —(NR^{N}—Lr—CO)x-, —(Lr—CO—NR^{N})x-, —(Lr—NR^{N}—CO)x-), a polysiloxane bond (—SiR^{P}₂—O—)x, and the like. x is an integer of 1 or more, preferably 1 to 500, and more preferably 1 to 100.

Lr is preferably an alkylene group, an alkenylene group, or an alkynylene group. The number of carbon atoms in Lr is preferably 1 to 12, more preferably 1 to 6, and particularly preferably 1 to 3 (however, for the alkenylene group and the alkynylene group, the lower limit of the number of carbon atoms is 2 or more). A plurality of Lr's, R^{N}'s, R^{P}'s, x's, and the like may be identical to or different from each other in the respective formulae respectively. The orientation of the linking groups is not limited to the above-described order and may be any orientation as long as the orientation is understood to be approximately in accordance with a predetermined chemical formula. For example, an amide bond (—CONR—) is a carbamoyl bond (—NR^{N}CO—).

Into the macromonomer (X), the reactive group may be introduced. The introduction method is the same as described in the section of the main chain. However, in the present invention, the reactive group is preferably introduced not into the side chain forming the macromonomer (X) but into the main chain.

The copolymerization fraction of a repeating unit derived from the macromonomer (X) is not particularly limited, but is preferably 1% by mass or more, more preferably 3% by mass or more, and particularly preferably 5% by mass or more in the polymer constituting the binder particles. The upper limit is preferably 70% by mass or less, more preferably 50% by mass or less, and particularly preferably 30% by mass or less.

Specification of Binder Particles

The mass average molecular weight of the polymer constituting the binder particles is preferably 5,000 or more, more preferably 10,000 or more, and particularly preferably 30,000 or more. The upper limit is preferably 1,000,000 or less and more preferably 200,000 or less. Meanwhile, in a case in which the binder is crosslinked and the molecular weight cannot be measured, what has been described above is not applicable. In addition, in a case in which crosslinking proceeds by heating or the application of voltage, the molecular weight may become larger. Preferably, the polymer forming the binder has a molecular weight in the above-described range when secondary batteries begin to be used.

The amount of the binder particles blended is preferably 0.1 parts by mass or more, more preferably 0.3 parts by mass or more, and particularly preferably 0.5 parts by mass or more with respect to 100 parts by mass of the inorganic solid electrolyte (including the active material in the case of being used). The upper limit is preferably 20 parts by mass or less, more preferably 10 parts by mass or less, and particularly preferably 5 parts by mass or less.

The content of the binder particles in the solid component is preferably 0.1% by mass or more, more preferably 0.3% by mass or more, and particularly preferably 1% by mass or more of the solid electrolyte composition. The upper limit is preferably 20% by mass or less, more preferably 10% by mass or less, and particularly preferably 5% by mass or less.

When the amount of the binder particles being used is in the above-described range, it is possible to more effectively realize both of the bonding properties with the solid electrolyte and the properties of suppressing interface resistance.

One kind of the binder particles may be used singly or two or more kinds of the binder particles may be used in combination. In addition, the binder particles may be used after being combined with other particles.

The average particle diameter of the binder particles in the present invention is preferably 1,000 nm or less, more preferably 700 nm or less, still more preferably 500 nm or less, particularly preferably 300 nm or less, and most preferably 250 nm or less. The lower limit value is preferably 10 nm or more, more preferably 30 nm or more, still more preferably 50 nm or more, and particularly preferably 100 nm or more. Unless particularly otherwise described, the average particle diameter of the binder particles in the present invention is measured under the conditions and definition in which the average particle diameter of the binder is measured in the section of examples below. When the sizes of the binder particles are set in the above-described range, it is possible to realize favorable adhesiveness and suppression of interface resistance.

Meanwhile, the measurement from a produced all solid state secondary battery can be carried out by, for example, disassembling the battery, peeling the electrodes off, then, carrying out measurement on the electrode materials on the basis of the method for measuring the particle diameter of the binder described below, and excluding the measurement values of the particle diameters of particles other than the binder which have been measured in advance.

The polymer constituting the binder particles in the present invention is preferably amorphous. The polymer in the present invention being “amorphous” means that, typically, no endothermic peaks attributed to crystal melting are observed in the polymer during measurements using the method for measuring glass transition temperatures (Tg) described below. The glass transition temperature of the polymer is preferably 130° C. or lower, more preferably 120° C. or lower, still more preferably 80° C. or lower, particularly preferably 60° C. or lower, and most preferably 30° C. or lower. The lower limit value is preferably −80° C. or higher, more preferably −60° C. or higher, still more preferably −50° C. or higher, and particularly preferably −40° C. or higher. Unless particularly otherwise described, the glass transition temperature of the polymer constituting the binder particles in the present invention is measured under the conditions in which the glass transition temperatures of polymers are measured in the section of examples described below.

Meanwhile, the measurement from a produced all solid state secondary battery can be carried out by, for example, disassembling the battery, putting electrodes into water so as to disperse the materials, carrying out filtration, collecting the remaining solids, and measuring glass transition temperatures using the method for measuring Tg described below.

The binder particles may be formed only of the polymer constituting the binder particles or may be constituted by including different kinds of materials (polymers, low-molecular-weight compounds, inorganic compounds, and the like). When different kinds of materials are used, the materials may be mixed with the binder particles and used in the same layer (for example, the positive electrode layer) or may be separately used in different layers (for example, the binder particles are used in the positive electrode layer and the SE layer, and the polymer is used in the negative electrode layer).

The binder particles may be crosslinked in the particles or among particles. Examples of the crosslinking method include a method in which a monomer having two reaction points is used during the synthesis of the binder particles, a method in which the binder particles are crosslinked by means of heating, and a method in which the binder particles are crosslinked by electron beams or ultraviolet rays. At this time the binder particles may be crosslinked using a crosslinking accelerator (for example, a polymerization initiator such as a radical polymerization initiator or a cationic polymerization initiator) or a crosslinking agent (for example, a compound having two reactive groups).

(Dispersion Medium)

In the solid electrolyte composition of the present invention, a dispersion medium dispersing the respective components described above is used. Examples of the dispersion medium include a variety of organic solvents. Specific examples of dispersion media include the following dispersion media.

Examples of alcohol compound solvents include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of ether compound solvents include dialkyl ether (dimethyl ether, diethyl ether, dipropyl ether, and dibutyl ether), alkylene glycol alkyl ethers (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, dipropylene glycol monomethyl ether, tripropylene glycol monomethyl ether, diethylene glycol monobutyl ether, diethylene glycol monobutyl ether, and the like), tetrahydrofuran, and dioxane.

Examples of amide compound solvents include N,N-dimethylformamide, 1-methyl-2-pyrrolidone, 2-pyrrolidinone, 1,3-dimethyl-2-imidazolidinone, 2-pyrrolidinone, ε-caprolactam, formamide, N-methylformamide, acetamide, N-methylacetamide, N,N-dimethylacetamide, N-methylpropanamide, and hexamethylphosphoric triamide.

Examples of amino compound solvents include triethylamine, diisopropylethylamine, tributylamine, and the like.

Examples of ketone compound solvents include acetone, methyl ethyl ketone, methyl isobutyl ketone, and cyclohexanone.

Examples of aromatic compound solvents include benzene, toluene, xylene, and the like.

Examples of aliphatic compound solvents include hexane, heptane, octane, and the like.

Examples of ester compound solvents include ethyl acetate, propyl acetate, butyl acetate, ethyl butyrate, butyl butyrate, butyl valerate, γ-butyrolactone, heptane, and the like.

Examples of carbonate compound solvents include ethylene carbonate, dimethyl carbonate, diethyl carbonate, ethyl methyl carbonate, propylene carbonate, and the like.

Examples of nitrile compound solvents include acetonitrile, propionitrile, and the like.

In the present invention, among these, the amino compound solvent, the ether compound solvents, the ketone compound solvents, the aromatic compound solvents, the aliphatic compound solvents, and the ester compound solvents are preferably used. In the present invention, it is preferable to use the sulfide-based solid electrolyte and, furthermore, select the specific organic solvent described above. When this combination is selected, no functional groups that are active with respect to the sulfide solid electrolyte are included, and thus the sulfide solid electrolyte can be stably handled, which is preferable.

The boiling point of the dispersion medium at normal pressure (one atmosphere) is preferably 50° C. or higher and more preferably 80° C. or higher. The upper limit is preferably 250° C. or lower and more preferably 220° C. or lower. The dispersion media may be used singly or two or more dispersion media may be used in combination.

In the present invention, the content of the dispersion medium in the solid electrolyte composition can be set to an arbitrary amount in consideration of the viscosity and the drying load of the solid electrolyte composition. Generally, the amount in the solid electrolyte composition is preferably 20 to 99% by mass.

The C Log P value of the dispersion medium being used in the present invention is preferably −1 or more, more preferably 0.4 or more, still more preferably 1 or more, and particularly preferably 2 or more. There are no particular upper limits, but the upper limit is realistically 10 or less. Specific examples thereof include toluene, xylene, hexane, heptane, octane, methyl ethyl ketone (MEK), dibutyl ether, ethyl acetate, butyl butyrate, tetrahydrofuran, tributylamine, and the like. Among these, toluene, xylene, hexane, heptane, dibutyl ether, and tributylamine are particularly preferred. When the C Log P value is set in the above-described range, the dispersion medium has no functional groups or hydrophobic substituents, and thus the sulfide solid electrolyte can be stably handled without being decomposed, the affinity to hydrophobic macromonomers having a high molecular weight is also favorable, and dispersibility can be improved, which is preferable. Hereinafter, the C Log P values of several dispersion media will be described together with chemical formulae.

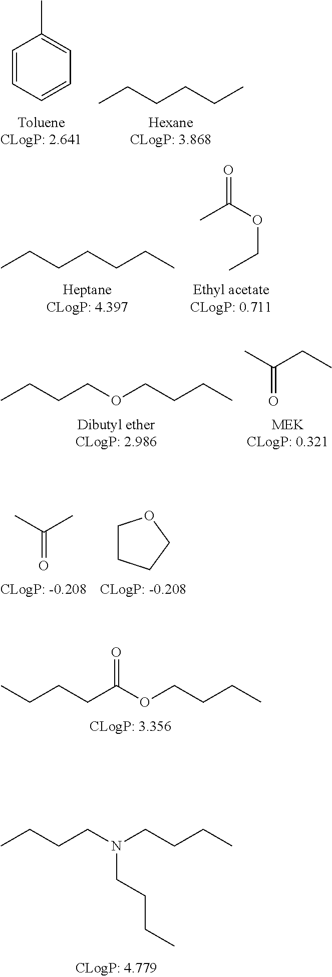

<Method for Estimating C Log P Value>

The C Log P value refers to a value of the common logarithm log P of the partition coefficient P into 1-octanol and water obtained by means of calculation. Regarding methods or software used for the calculation of the C Log P value, well-known methods and software can be used; however, unless particularly otherwise described, in the present invention, structures are drawn and computed using ChemDraw manufactured by Perkin Elmer, Inc.

(Supporting Electrolytes [Lithium Salts or the Like])

The present invention may further include a supporting electrolyte. Supporting electrolytes (lithium salts or the like) that can be used in the present invention are preferably lithium salts that are generally used in this kind of products and are not particularly limited, and examples of preferred supporting electrolytes include the following electrolytes.

(L-1) Inorganic Lithium Salts

Examples thereof include the following compounds.

Inorganic fluoride salts such as LiPF₆, LiBF₄, LiAsF₆, and LiSbF₆

Perhalogen acids such as LiClO₄, LiBrO₄, and LiIO₄

Inorganic chloride salts such as LiAlCl₄

(L-2) Fluorine-Containing Organic Lithium Salts

Examples thereof include the following compounds.

Perfluoroalkanesulfonate salts such as LiCF₃SO₃

Perfluoroalkanesulfonylimide salts such as LiN(CF₃SO₂)₂, LiN(CF₃CF₂SO₂)₂, LiN(FSO₂)₂, LiN(CF₃SO₂)(C₄F₉SO₂)

Perfluoroalkanesulfonyl methide salts such as LiC(CF₃SO₂)₃

Fluoroalkyl fluorophosphates salts such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)_{3]}

(L-3) Oxalate Borate Salts

Examples thereof include the following compounds.

Lithium bis(oxalato)borate, lithium difluorooxalatoborate, and the like

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂) are preferred, and lithium imide salts such as LiPF₆, LiBF₄, LiN(Rf¹SO₂)₂, LiN(FSO₂)₂, and LiN(Rf¹SO₂)(Rf²SO₂) are more preferred. Here, Rf¹ and Rf² each represent a perfluoroalkyl group.

Meanwhile, electrolytes being used in electrolytic solutions may be used singly or two or more electrolytes may be arbitrarily combined together.

The content of the lithium salt is preferably 0.1 parts by mass or more and more preferably 0.5 parts by mass or more with respect to 100 parts by mass of the solid electrolyte. The upper limit is preferably 10 parts by mass or less and more preferably 5 parts by mass or less.

(Positive Electrode Active Material)

To the solid electrolyte composition of the present invention, a positive electrode active material may be added. In such a case, the solid electrolyte composition can be used as a composition for positive electrode materials. As the positive electrode active material, transition metal oxides are preferably used, and, among these, the positive electrode active material preferably has transition elements M^{a} (one or more elements selected from Co, Ni, Fe, Mn, Cu, and V). In addition, mixing elements M^{b} (metal elements belonging to Group I (la) of the periodic table other than lithium, elements belonging to Group II (IIa), Al, Ga, In, Ge, Sn, Pb, Sb, Bi, Si, P, B, and the like) may be mixed into the positive electrode active material.

Examples of the transition metal oxides include specific transition metal oxides including transition metal oxides represented by any one of Formulae (MA) to (MC) and additionally include V₂O₅, MnO₂, and the like. Examples of positive electrode active materials other than the transition metal oxide include nickel sulfide, sulfur, lithium sulfide, and the like, and these are also preferred positive electrode active materials. As the positive electrode active material, a particulate positive electrode active material may be used. Specifically, transition metal oxides capable of reversibly intercalating and deintercalating lithium ions can be used, and the specific transition metal oxides described above are preferably used.

Preferred examples of the transition metal oxides include oxides including the transition element M^{a} and the like. At this time, the mixing elements M^{b} (preferably Al) may be mixed into the positive electrode active material. The amount mixed is preferably 0 to 30 mol % with respect to the amount of the transition metal. Transition metal oxides synthesized by mixing Li and the transition metal so that the molar ratio of Li/M^{a} reaches 0.3 to 2.2 are more preferred.

[Transition Metal Oxide Represented by Formula (MA) (Bedded Salt-Type Structure)]

As lithium-containing transition metal oxides, among them, transition metal oxides represented by Formula (MA) are preferred.

LiₐM^{l}O_{b} Formula (MA)

In the formula, M¹ is the same as M^{a}. a represents 0 to 1.2 (preferably 0.2 to 1.2) and is preferably 0.6 to 1.1. b represents 1 to 3 and is preferably 2. A part of M¹ may be substituted with the mixing element M^{b}. The transition metal oxides represented by Formula (MA) typically have a bedded salt-type structure.

The present transition metal oxides are more preferably transition metal oxides represented by individual formulae described below.

Li_{g}CoOₖ Formula (MA-1)

Li_{g}NiOₖ Formula (MA-2)

Li_{g}MnOₖ Formula (MA-3)

Li_{g}CoⱼNiₗ₋ⱼOₖ Formula (MA-4)

Li_{g}NiⱼMnₗ₋ⱼOₖ Formula (MA-5)

Li_{g}CoⱼNiᵢAlₗ₋ⱼ₋ᵢOₖ Formula (MA-6)

Li_{g}CoⱼNiᵢMnₗ₋ⱼ₋ᵢOₖ Formula (MA-7)

Here, g is the same as a. j represents 0.1 to 0.9. i represents 0 to 1. However, l-j-i reaches 0 or more. k is the same as b. Specific examples of the transition metal oxides include LiCoO₂ (lithium cobalt oxide [LCO]), LiNi₂O₂ (lithium nickelate), LiNi_{0.85}Co_{0.01}Al_{0.05}O₂ (lithium nickel cobalt aluminum oxide [NCA]), LiNi_{0.33}Co_{0.33}Mn_{0.33}O₂ (lithium nickel manganese cobalt oxide [NMC]), and LiNi_{0.5}Mn_{0.5}O₂ (lithium manganese nickelate).

Although there is partial duplication in expression, preferred examples of the transition metal oxides represented by Formula (MA) include transition metal oxides represented by formulae below when expressed in a different manner.

Li_{g}NiₓMn_{y}Co_{z}O₂(x>0.2,y>0.2,z≧0,x+y+z=1) (i)

Typical Transition Metal Oxides:

Li_{g}Ni_{1/3}Mn_{1/3}Co_{1/3}O₂

Li_{g}Ni_{1/2}Mn_{1/2}O₂

Li_{g}NiₓCo_{y}Al_{z}O₂(x>0.7,y>0.1,0.1≧z≧0.05,x+y+z=1) (ii)

Typical Transition Metal Oxides:

Li_{g}Ni_{0.8}Co_{0.15}Al_{0.05}O₂

[Transition Metal Oxide Represented by Formula (MB) (Spinel-Type Structure)]

As lithium-containing transition metal oxides, among them, transition metal oxides represented by Formula (MB) are also preferred.

Li_{c}M²²O_{d} Formula (MB)

In the formula, M² is the same as M^{a}. c represents 0 to 2 (preferably 0.2 to 2) and is preferably 0.6 to 1.5. d represents 3 to 5 and is preferably 4.

The transition metal oxides represented by Formula (MB) are more preferably transition metal oxides represented by individual formulae described below.

LiₘMn₂Oₙ Formula (MB-1)

LiₘMnₚAl₂₋ₚOₙ Formula (MB-2)

LiₘMnₚNi₂₋ₚOₙ Formula (MB-3)

m is the same as c. n is the same as d. p represents 0 to 2. Specific examples of the transition metal oxides include LiMn₂O₄, LiMn_{1.5}Ni_{0.5}O₄.

Preferred examples of the transition metal oxides represented by Formula (MB) further include transition metal oxides represented by formulae below.

LiCoMnO₄ Formula (a)

Li₂FeMn₃O₈ Formula (b)

Li₂CuMn₃O₈ Formula (c)

Li₂CrMn₃O₈ Formula (d)

Li₂NiMn₃O₈ Formula (e)

From the viewpoint of a high capacity and a high output, among the above-described transition metal oxides, electrodes including Ni are still more preferred.

[Transition Metal Oxide Represented by Formula (MC)]

As lithium-containing transition metal oxides, lithium-containing transition metal phosphorus oxides are preferably used, and, among these, transition metal oxides represented by Formula (MC) are also preferred.

LiₑM³(PO₄)_{f} Formula (MC)

In the formula, e represents 0 to 2 (preferably 0.2 to 2) and is preferably 0.5 to 1.5. f represents 1 to 5 and is preferably 0.5 to 2.

M³ represents one or more elements selected from V, Ti, Cr, Mn, Fe, Co, Ni, and Cu. M³ may be substituted with not only the mixing element M^{b} but also other metal such as Ti, Cr, Zn, Zr, or Nb. Specific examples include olivine-type iron phosphate salts such as LiFePO₄ and Li₃Fe₂(PO₄)₃, iron pyrophosphates such as LiFeP₂O₇, cobalt phosphates such as LiCoPO₄, monoclinic nasicon-type vanadium phosphate salt such as Li₃V₂(PO₄)₃ (lithium vanadium phosphate).

Meanwhile, the a, c, g, m, and e values representing the composition of Li are values that change due to charging and discharging and are, typically, evaluated as values in a stable state when Li is contained. In Formulae (a) to (e), the composition of Li is expressed using specific values, but these values also change due to the operation of batteries.

The average particle diameter of the positive electrode active material being used in the present invention is not particularly limited, but is preferably 0.1 μm to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. The method for measuring the average particle diameter of the positive electrode active material particles is based on the method for measuring the average particle diameter of inorganic particles described in the section of examples described below.

The concentration of the positive electrode active material is not particularly limited. Meanwhile, the concentration in the solid electrolyte composition is preferably 20 to 90% by mass and more preferably 40 to 80% by mass with respect to 100% by mass of the solid component.

(Negative Electrode Active Material)

To the solid electrolyte composition of the present invention, a negative electrode active material may be added. In such a case, the solid electrolyte composition can be used as a composition for negative electrode materials. As the negative electrode active material, negative electrode active materials capable of reversibly intercalating and deintercalating lithium ions are preferred. These materials are not particularly limited, and examples thereof include carbonaceous materials, metal oxides such as tin oxide and silicon oxide, metal complex oxides, a lithium single body or lithium alloys such as lithium aluminum alloys, metals capable of forming alloys with lithium such as Sn, Si, In, and Al and the like. These materials may be used singly or two or more materials may be jointly used in an arbitrary combination and ratios. Among these, carbonaceous materials or lithium complex oxides are preferably used in terms of reliability. In addition, the metal complex oxides are preferably capable of absorbing and emitting lithium. The materials are not particularly limited, but preferably contain at least one atom selected from titanium or lithium as a constituent component from the viewpoint of high-current density charging and discharging characteristics.

The carbonaceous materials being used as the negative electrode active material are materials substantially made of carbon. Examples thereof include petroleum pitch, natural graphite, artificial graphite such as highly oriented pyrolytic graphite, and carbonaceous material obtained by firing a variety of synthetic resins such as PAN-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated PVA-based carbon fibers, lignin carbon fibers, glassy carbon fibers, and active carbon fibers, mesophase microspheres, graphite whisker, flat graphite, and the like.

These carbonaceous materials can also be classified into non-graphitizable carbon materials and graphite-based carbon materials depending on the degree of graphitization. In addition, the carbonaceous materials preferably have the surface separation, the density, and the sizes of crystallites described in JP1987-22066A (JP-S62-22066A), JP1990-6856A (JP-H02-6856A), and JP1991-45473A (JP-H03-45473A). The carbonaceous materials do not need to be a sole material, and it is also possible to use the mixtures of a natural graphite and a synthetic graphite described in JP1993-90844A (JP-H05-90844A), the graphite having a coated layer described in JP1994-4516A (JP-H06-4516A), and the like.

The metal oxides and the metal complex oxides being applied as the negative electrode active material are particularly preferably amorphous oxides, and furthermore, chalcogenides which are reaction products between a metal element and an element belonging to Group XVI of the periodic table are also preferably used. The amorphous oxides mentioned herein refer to oxides having a broad scattering band having a peak of a 20 value in a range of 20° to 40° in an X-ray diffraction method in which CuKα rays are used and may have crystalline diffraction lines. The highest intensity in the crystalline diffraction line appearing at the 20 value of 40° or more and 70° or less is preferably 100 times or less and more preferably five times or less of the diffraction line intensity at the peak of the broad scattering line appearing at the 20 value of 20° or more and 40° or less and particularly preferably does not have any crystalline diffraction lines.

In a compound group consisting of the amorphous oxides and the chalcogenides, amorphous oxides of semimetal elements and chalcogenides are more preferred, and elements belonging to Groups XIII (IIIB) to XV (VB) of the periodic table, oxides made of one element or a combination of two or more elements of Al, Ga, Si, Sn, Ge, Pb, Sb, and Bi, and chalcogenides are particularly preferred. Specific examples of preferred amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, SnSiS₃, and the like. In addition, these amorphous oxides may be complex oxides with lithium oxide, for example, Li₂SnO₂.

The average particle diameter of the negative electrode active material is preferably 0.1 μm to 60 μm. In order to provide a predetermined particle diameter, a well-known crusher or classifier is used. For example, a mortar, a ball mill, a sand mill, an oscillatory ball mill, a satellite ball mill, a planetary ball mill, a swirling airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind powder classifier, or the like depending on the necessity. Both of dry-type classification and wet-type classification can be carried out. The method for measuring the average particle diameter of the negative electrode active material particles is based on the method for measuring the average particle diameter of the inorganic particles described in the section of examples described below.

The chemical formula of the compound obtained using the firing method can be computed using inductively coupled plasma (ICP) emission spectrometry as the measurement method or from the mass difference of powder before and after firing as a convenient method.

Preferred examples of negative electrode active materials that can be jointly used in the amorphous oxide negative electrode active material mainly containing Sn, Si, or Ge include carbon materials capable of absorbing and emitting lithium ions or lithium metals, lithium, lithium alloys, and metals capable of forming alloys with lithium.

In the present invention, it is also preferable to apply Si-based negative electrodes. Generally, Si negative electrodes are capable of absorbing a larger number of Li ions than carbon negative electrodes (graphite, acetylene black, and the like). That is, the amount of Li ions absorbed per unit mass increases. Therefore, it is possible to increase battery capacities. As a result, there is an advantage of becoming capable of elongating the battery-operating time.

The concentration of the negative electrode active material is not particularly limited, but is preferably 10 to 80% by mass and more preferably 20 to 70% by mass with respect to 100% by mass of the solid component in the solid electrolyte composition. Meanwhile, when the negative electrode layer includes other inorganic solids (for example, solid electrolytes), the above-described concentration is interpreted to include the inorganic solids.

Meanwhile, in the above-described embodiment, an example in which the positive electrode active material or the negative electrode active material is added to the solid electrolyte composition according to the present invention has been described, but the present invention is not interpreted to be limited thereto. For example, paste including a positive electrode active material or a negative electrode active material may be prepared using an ordinary binder. In addition, to the active material layers in the positive electrode and the negative electrode, a conduction aid may be appropriately added as necessary. As an ordinary conduction aid, it is possible to add graphite, carbon black, acetylene black, Ketjenblack, a carbon fiber, metal powder, a metal fiber, a polyphenylene derivative, or the like as an electron-conducting material.

<Collector (Metal Foil)>

As the collector of the positive or negative electrode, an electron conductor that does not chemically change is preferably used. The collector of the positive electrode is preferably a collector obtained by treating the surface of aluminum or stainless steel with carbon, nickel, titanium, or silver in addition to aluminum, stainless steel, nickel, titanium, or the like, and, among these, aluminum and aluminum alloys are more preferred. The collector of the negative electrode is preferably aluminum, copper, stainless steel, nickel, or titanium and more preferably aluminum, copper, or a copper alloy.

Regarding the shape of the collector, generally, collectors having a film sheet-like shape are used, but it is also possible to use nets, punched collectors, lath bodies, porous bodies, foams, compacts of fiber groups, and the like. The thickness of the collector is not particularly limited, but is preferably 1 μm to 500 μm. In addition, the surface of the collector is preferably provided with protrusions and recesses by means of a surface treatment.

<Production of all Solid State Secondary Battery>

The all solid state secondary battery may be produced using an ordinary method. Specific examples thereof include a method in which the solid electrolyte composition is applied onto a metal foil that serves as the collector and an electrode sheet for a battery on which a coated film is formed is produced. For example, a composition serving as a positive electrode collector is applied onto a metal foil which is the positive electrode layer and then dried, thereby forming a positive electrode layer. Next, the solid electrolyte composition is applied onto a positive electrode sheet for a battery and then dried, thereby forming a solid electrolyte layer. Furthermore, a composition serving as a negative electrode material is applied and dried thereon, thereby forming a negative electrode layer. A collector (metal foil) for the negative electrode side is overlaid thereon, whereby it is possible to obtain a structure of the all solid state secondary battery in which the solid electrolyte layer is sandwiched between the positive electrode layer and the negative electrode layer. Meanwhile, the respective compositions described above may be applied using an ordinary method. At this time, after the application of each of the composition forming the positive electrode active material layer, the composition forming the inorganic solid electrolyte layer (the solid electrolyte composition), and the composition forming the negative electrode active material layer, a heating treatment may be carried out or a heating treatment may be carried out after the application of multiple layers. The heating temperature is not particularly limited, but is preferably 30° C. or higher, more preferably 60° C. or higher, and still more preferably 80° C. or higher. The upper limit is preferably 300° C. or lower, more preferably 250° C. or lower, and still more preferably 200° C. or lower. When the compositions are heated in the above-described temperature range, it is possible to remove the dispersion medium and cause the compositions to fall into a solid state. In addition, the temperature is not excessively increased, and individual dissociated members are not damaged, which is preferable. Therefore, in all solid state secondary batteries, excellent general performance is exhibited, and favorable bonding properties and ion conductivity in the absence of pressure can be obtained.

<Applications of all Solid State Secondary Battery>

The all solid state secondary battery of the present invention can be applied to a variety of applications. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, memory cards, portable tape recorders, radios, backup power supplies, and the like. Additionally, examples of consumer applications include automobiles, electric vehicles, motors, lighting equipment, toys, game devices, road conditioners, watches, strobes, cameras, medical devices (pacemakers, hearing aids, shoulder massage devices, and the like), and the like. Furthermore, the all solid state secondary battery can be used for a variety of military applications and universe applications. In addition, the all solid state secondary battery can also be combined with solar batteries.

Among these, the all solid state secondary battery is preferably applied to applications for which a high capacity and high rate discharging characteristics are required. For example, in electricity storage facilities expected to have a high capacity in the future, high reliability becomes essential, and furthermore, the satisfaction of battery performance is required. In addition, high-capacity secondary batteries are mounted in electric vehicles and the like and are assumed to be used in domestic applications in which charging is carried out every day, and thus better reliability and durability are required. According to the present invention, it is possible to preferably cope with the above-described application aspects and exhibit excellent effects.

According to the preferred embodiment of the present invention, individual application aspects as described below are derived.
(1) Solid electrolyte compositions including active materials capable of intercalating and deintercalating ions of metals belonging to Group I or II of the periodic table (electrode compositions for positive electrodes and negative electrodes)
(2) Electrode sheets for a battery in which a film of the solid electrolyte composition is formed on a metal foil
(3) All solid state secondary batteries equipped with a positive electrode active material layer, a negative electrode active material layer, and a solid electrolyte layer in which at least one of the positive electrode active material layer, the negative electrode active material layer, or the solid electrolyte layer are layers constituted of the solid electrolyte composition
(4) Methods for manufacturing electrode sheets for a battery in which the solid electrolyte composition is disposed on a metal foil, and a film thereof is formed
(5) Methods for manufacturing an all solid state secondary battery in which all solid state secondary batteries are manufactured through the method for manufacturing an electrode sheet for a battery

In addition, the preferred embodiment of the present invention has advantages of becoming capable of forming the binder particles without injecting any surfactants and being capable of reducing accompanying hindrance causes for side reactions and the like. In addition, accordingly, a layer transfer emulsification step can be eliminated, and thus manufacturing efficiency is also relatively improved.

All solid state secondary batteries refer to secondary batteries in which the positive electrode, the negative electrode, and the electrolyte are all constituted of solid. In other words, all solid state secondary batteries are differentiated from electrolytic solution-type secondary batteries in which a carbonate-based solvent is used as the electrolyte. Among these, the present invention is assumed to be an inorganic all solid state secondary battery. All solid state secondary batteries are classified into organic (high-molecular-weight) all solid state secondary batteries in which a high-molecular-weight compound such as polyethylene oxide is used as the electrolyte and inorganic all solid state secondary batteries in which Li—P—S or the like is used. Meanwhile, the application of high-molecular-weight compounds to inorganic all solid state secondary batteries is not inhibited, and high-molecular-weight compounds can be applied as the positive electrode active material, the negative electrode active material, and the binder of the inorganic solid electrolyte particles.

Inorganic solid electrolytes are differentiated from electrolytes in which the above-described high-molecular-weight compound is used as an ion conductive medium (high-molecular-weight electrolyte), and inorganic compounds serve as ion conductive media. Specific examples thereof include Li—P—S. Inorganic solid electrolytes do not emit positive ions (Li ions) and exhibit an ion transportation function. In contrast, there are cases in which materials serving as an ion supply source which is added to electrolytic solutions or solid electrolyte layers and emits positive ions (Li ions) are referred to as electrolytes; however, when differentiated from electrolytes as the ion transportation materials, the materials are referred to as “electrolyte salts” or “supporting electrolytes”. Examples of the electrolyte salts include lithium bistrifluoromethanesulfonimide (LiTFSI).

In the present invention, “compositions” refer to mixtures obtained by uniformly mixing two or more components. However, compositions may partially include agglomeration or uneven distribution as long as the compositions substantially maintain uniformity and exhibit desired effects.

### EXAMPLES

Hereinafter, the present invention will be described in more detail on the basis of examples, but the present invention is not interpreted to be limited thereto. Meanwhile, unless particularly otherwise described, formulations described in the present examples is mass-based.

### Example 1

(Synthesis Example of High-Molecular-Weight Compound)

To a 1 L three-neck flask equipped with a reflux cooling pipe and a gas introduction cock, a 43% by mass heptane solution of Macromonomer M-1 (47 parts by mass) and heptane (60 parts by mass) were added, nitrogen gas was introduced thereinto for ten minutes at a flow rate of 200 mL/min, and then the components were heated to 80° C. A liquid prepared in another container (a liquid obtained by mixing a 43% by mass heptane solution of Macromonomer M-1 (93 parts by mass), methyl methacrylate [A-4] (manufactured by Wako Pure Chemical Industrial Ltd.) (130 parts by mass), acrylic acid [A-1] (manufactured by Wako Pure Chemical Industrial Ltd.) (10 parts by mass), and V-601 (manufactured by Wako Pure Chemical Industrial Ltd.) (1.1 parts by mass)) was added dropwise thereto for two hours, and then the components were stirred at 80° C. for two hours. After that, V-601 (0.2 parts by mass) was added thereto, and furthermore, the components were stirred at 95° C. for two hours. After the mixture was cooled to room temperature, heptane (300 parts by capacity) was added thereto, and filtration was carried out, thereby obtaining a dispersion liquid of Resin B-1. The concentration of the solid content was 33.2%, and the particle diameter was 185 nm. The mass average molecular weight of Resin B-1 was 105,000, and Tg was 121° C.

Resin B-2 was synthesized in the same manner as Resin B-1 except for the fact that the dropwise addition speed was changed from two hours to 30 minutes.

Resins B-3 to B-10 were synthesized in the same manner as Resin B-1 except for the fact that monomers or macromonomers were changed so as to obtain the compositions in Table 1 below.

In the table, blank cells indicate that the monomer was not used.

TABLE 1

| | M1 | | M2 | | M3 | | M4 | | MM | | | | |
|---|---|---|---|---|---|---|---|---|---|---|---|---|---|
| No. | | % | | % | | % | | % | | % | SP value | Tg ° C. | PD nm |
| B-1 | A-4 | 65 | A-1 | 5 | | | | | M-1 | 30 | 9.1 | 121 | 185 |
| B-2 | A-4 | 65 | A-1 | 5 | | | | | M-1 | 30 | 9.1 | 121 | 536 |
| B-3 | A-3 | 52 | A-4 | 13 | A-1 | 5 | | | M-1 | 30 | 9.1 | 45 | 181 |
| B-4 | A-34 | 30 | A-36 | 35 | A-1 | 5 | | | M-1 | 30 | 9.1 | 5 | 202 |
| B-5 | A-5 | 52 | A-4 | 13 | A-1 | 5 | | | M-1 | 30 | 9.1 | −13 | 176 |
| B-6 | A-5 | 52 | A-4 | 13 | A-27 | 5 | | | M-1 | 30 | 9.1 | −15 | 192 |
| B-7 | A-3 | 45 | A-4 | 10 | A-1 | 15 | | | M-1 | 30 | 9.1 | 53 | 177 |
| B-8 | A-5 | 51 | A-4 | 13 | A-1 | 5 | A-59 | 1 | M-1 | 30 | 9.1 | −11 | 167 |
| B-9 | A-3 | 52 | A-4 | 13 | A-1 | 5 | | | M-4 | 30 | 9.3 | 43 | 190 |
| B-10 | A-3 | 52 | A-4 | 13 | A-1 | 5 | | | M-5 | 30 | 9.1 | 47 | 204 |

<Note in the table>
“%” in the table indicates “% by mass” (corresponding to copolymerization fractions).
M1 to M4: Monomers
MM: Macromonomer
SP value: The SP values of the macromonomers
Tg: Tg (glass transition temperature) of the binders
PD: The average particle diameter of the binder particles

### Synthesis Example of Macromonomer M-1

To a 1 L three-neck flask equipped with a reflux cooling pipe and a gas introduction cock, toluene (190 parts by mass) was added, nitrogen gas was introduced thereinto for ten minutes at a flow rate of 200 mL/min, and then the components were heated to 80° C. A liquid prepared in another container was added dropwise thereto for two hours, and then the components were stirred at 80° C. for two hours. After that, V-601 (0.2 parts by mass) was added thereto, and furthermore, the components were stirred at 95° C. for two hours. After the stirring, 2,2,6,6-tetramethylpiperidine-1-oxyl (manufactured by Tokyo Chemical Industry Co., Ltd.) (0.025 parts by mass), glycidyl methacrylate (manufactured by Wako Pure Chemical Industrial Ltd.) (13 parts by mass), and tetrabutylammonium bromide (manufactured by Tokyo Chemical Industry Co., Ltd.) (2.5 parts by mass) were added to a solution held at 95° C. after being stirred and stirred in the atmosphere at 120° C. for three hours. The mixture was cooled to room temperature, precipitation was caused by adding methanol thereto, the precipitate was washed twice with methanol and then dried by blast drying at 50° C. The obtained solid was dissolved in heptane (300 parts by mass), thereby obtaining a solution of Macromonomer M-1. The concentration of the solid content was 43.4%, the SP value was 9.1, and the mass average molecular weight was 16,000.

(Formulation α)
Dodecyl methacrylate MM-2 (manufactured by Wako Pure Chemical Industrial Ltd.) 150 parts by mass
Methyl methacrylate A-4 (manufactured by Wako Pure Chemical Industrial Ltd.) 59 parts by mass
3-Mercaptoisobutyric acid (manufactured by Tokyo Chemical Industry Co., Ltd.) 2 parts by mass
V-601 (manufactured by Wako Pure Chemical Industrial Ltd.) 1.9 parts by mass

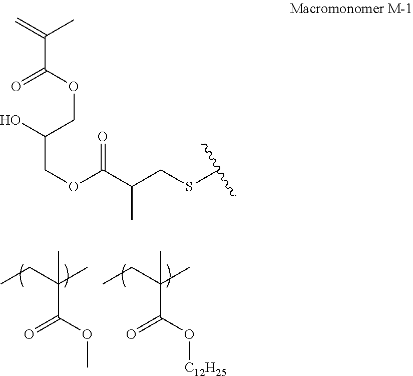

### Synthesis Example of Macromonomer M-2

Glycidyl methacrylate (manufactured by Tokyo Chemical Industry Co., Ltd.) was reacted with a self-condensate (GPC polystyrene standard mass average molecular weight: 9,000) of 12-hydroxystearic acid (manufactured by Wako Pure Chemical Industrial Ltd.), thereby obtaining Macromonomer M-2. The ratio between 12-hydroxystearic acid and glycidyl methacrylate was set to 99:1 (molar ratio). The SP value of Macromonomer M-2 was 9.2, and the mass average molecular weight was 9,000.

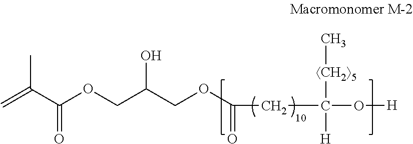

### Synthesis Example of Macromonomer M-3

4-Hydroxystrene (manufactured by Wako Pure Chemical Industrial Ltd.) was reacted with a self-condensate (GPC polystyrene standard mass average molecular weight: 2,000) of 12-hydroxystearic acid (manufactured by Wako Pure Chemical Industrial Ltd.), thereby obtaining Macromonomer M-3. The ratio between 12-hydroxystearic acid and 4-hydroxystrene was set to 99:1 (molar ratio). The SP value of Macromonomer M-3 was 9.2, and the mass average molecular weight was 2,100.

(Macromonomer M-4)

One terminal methacryloylated poly-n-butylacrylate oligomer (Mw=13,000, trade name: AB-6, manufactured by Toagosei Co., Ltd.) was used as Macromonomer M-4. The SP value of Macromonomer M-4 was 9.3.

### Synthesis Example of Macromonomer M-5

To a 1 L three-neck flask equipped with a reflux cooling pipe and a gas introduction cock, toluene (190 parts by mass) was added, nitrogen gas was introduced thereinto for ten minutes at a flow rate of 200 mL/min, and then the components were heated to 80° C. A liquid prepared in another container (Formulation β) was added dropwise thereto for two hours, and then the components were stirred at 80° C. for two hours. After that, V-601 (0.2 parts by mass) was added thereto, and furthermore, the components were stirred at 95° C. for two hours. After the stirring, 2,2,6,6-tetramethylpiperidine-1-oxyl free radicals (manufactured by Tokyo Chemical Industry Co., Ltd.) (0.025 parts by mass), glycidyl methacrylate (manufactured by Wako Pure Chemical Industrial Ltd.) (13 parts by mass), and tetrabutylammonium bromide (manufactured by Tokyo Chemical Industry Co., Ltd.) (2.5 parts by mass) were added to a solution held at 95° C. after being stirred and stirred in the atmosphere at 120° C. for three hours. The mixture was cooled to room temperature, precipitation was caused by adding methanol thereto, the precipitate was washed twice with methanol and then dried by blast drying at 50° C. The obtained solid was dissolved in heptane (400 parts by mass), thereby obtaining a solution of Macromonomer M-5. The concentration of the solid content was 38.1%, the SP value was 9.2, and the mass average molecular weight was 3,500.

(Formulation β)
Dodecyl methacrylate MM-2 (manufactured by Wako Pure Chemical Industrial Ltd.) 150 parts by mass
Methyl methacrylate A-4 (manufactured by Wako Pure Chemical Industrial Ltd.) 59 parts by mass
Acrylic acid (manufactured by Wako Pure Chemical Industrial Ltd.) 2 parts by mass
V-601 (manufactured by Wako Pure Chemical Industrial Ltd.) 5 parts by mass

### Preparation Example of Solid Electrolyte Composition

180 zirconia beads having a diameter of 5 mm were injected into a 45 mL zirconia container (manufactured by Fritsch Japan Co., Ltd.), the sulfide solid electrolyte synthesized above (4.85 g), each of resins (B-1 and the like) (0.15 g) (solid component mass), and heptane or the like a dispersion medium (17.0 g) were injected thereinto. After that, the container was set in a planetary ball mill manufactured by Fritsch Japan Co., Ltd., and the components were continuously stirred at a rotation speed of 300 rpm for two hours, thereby obtaining individual solid electrolyte compositions.

In the table, blank cells indicate that the dispersion medium was not used.

TABLE 2

| | Solid electrolyte | | Binder | | Dispersion | CLog P |
|---|---|---|---|---|---|---|
| Composition | | % | | % | medium | value |
| S-1 | Li/P/S | 97% | B-1 | 3% | Heptane | 4.40 |
| S-2 | Li/P/S | 97% | B-2 | 3% | Heptane | 4.40 |
| S-3 | Li/P/S | 97% | B-3 | 3% | Heptane | 4.40 |
| S-4 | Li/P/S | 97% | B-3 | 3% | DBE | 2.99 |
| S-5 | Li/P/S | 97% | B-3 | 3% | MEK | 0.32 |
| S-6 | Li/P/S | 97% | B-4 | 3% | Heptane | 4.40 |
| S-7 | Li/P/S | 97% | B-5 | 3% | Heptane | 4.40 |
| S-8 | Li/P/S | 97% | B-6 | 3% | Heptane | 4.40 |
| S-9 | Li/P/S | 97% | B-7 | 3% | Heptane | 4.40 |
| S-10 | Li/P/S | 97% | B-8 | 3% | Heptane | 4.40 |
| S-11 | Li/P/S | 97% | B-9 | 3% | Heptane | 4.40 |
| S-12 | Li/P/S | 97% | B-10 | 3% | Heptane | 4.40 |
| T-1 | Li/P/S | 97% | PTFE | 3% | | |
| T-2 | Li/P/S | 97% | BC-1 | 3% | Toluene | 2.64 |
| T-3 | Li/P/S | 97% | HBR | 3% | Heptane | 4.40 |
| T-s1 | LLZ | 97% | B-2 | 3% | Heptane | 4.40 |

<Note in the Table>

The units of numerical values in the table are ‘mass percentage (%)’.

Regarding the numbers of compounds, examples of the exemplary compounds are referred to.

C Log P values: The C Log P values of dispersion media

DBE: Dibutyl ether

MEK: Methyl ethyl ketone

Li/P/S: Sulfide solid electrolyte synthesized below

LLZ: Li₇La₃Zr₂O₁₂

PTFE: Polytetrafluoroethylene particles

HBR: Hydrogenated butadiene rubber (average molecular weight: 130,000)

BC-1: Polymer Synthesized Using the Following Method

n-Butyl acrylate (700 parts by mass), styrene (200 parts by mass), methacrylic acid (5 parts by mass), divinyl benzene (10 parts by mass), polyoxyethylene lauryl ether (manufactured by Kao Corporation, EMULGEN 108, non-ionic surfactant, the number of carbon atoms in an alkyl group was 12, HLB value: 12.1) (25 parts by mass) as an emulsifier, ion exchange water (1,500 parts by mass), and 2,2′-azobizisobutyronitrile (15 parts by mass) as a polymerization initiator were fed into an autoclave and sufficiently stirred. After that, the components were heated to 80° C., and polymerization was caused. In addition, after the initiation of polymerization, the components were cooled so as to stop the polymerization reaction, thereby obtaining latex of polymer particles.

Li/P/S: Sulfide Solid Electrolyte Synthesized Below

In a globe box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) were respectively weighed and injected into a mortar. Meanwhile, the molar ratio between Li₂S and P₂S₅ was set to Li₂S:P₂S₅=75:25. The components were mixed together for five minutes in the agate mortar using an agate muddler.

Zirconia beads (66 g) having a diameter of 5 mm were injected into a 45 mL zirconia container (manufactured by Fritsch Japan Co., Ltd.), the total amount of the mixture was injected thereinto, and the container was completely sealed in an argon atmosphere. The container was set in a planetary ball mill P-7 manufactured by Fritsch Japan Co., Ltd., mechanical milling was carried out at 25° C. and a rotation speed of 510 rpm for 20 hours, thereby obtaining yellow powder (6.20 g) of a sulfide solid electrolyte material (Li/P/S glass).

### Production Example of Solid Electrolyte Sheet [Electrode Sheet]

Each of the solid electrolyte compositions obtained above was applied onto a 20 μm-thick aluminum foil using an applicator having an arbitrary clearance, heated at 80° C. for one hour, furthermore, heated at 120° C. for one hour, and a coating solvent was dried. After that, the composition was heated and pressurized using a heat press machine so as to obtain an arbitrary density, thereby manufacturing a solid electrolyte sheet (electrode sheet). The film thickness of the electrolyte layer was 50 μm. Other solid electrolyte sheets were also prepared using the same method. The following tests were carried out, and the obtained results are shown in Table 3 below.

<Measurement of Ion Conductivity>

A disc-shaped piece having a diameter of 14.5 mm was cut out from the solid electrolyte sheet obtained above and put into a coin case. Specifically, a disc-shaped piece having a diameter of 15 mm cut out from an aluminum foil was brought into contact with the solid electrolyte layer, a spacer and a washer were combined thereinto, and the disc-shaped piece was put into a 2032-type stainless steel coin case. The coin case was swaged, thereby producing a cell for measuring the ion conductivity (refer to FIG. 2 regarding the test subject: Reference sign 11 indicates the coin case, reference sign 12 indicates the solid electrolyte electrode sheet, and reference sign 13 indicates the coin battery).

The ion conductivity was measured using the cell for measuring the ion conductivity obtained above.

Specifically, the alternating-current impedance was measured in a constant-temperature tank (30° C.) using a 1255B FREQUENCY RESPONSE ANALYZER (trade name) manufactured by Solartron Metrology at a voltage amplitude of 5 mV and a frequency in a range of 1 MHz to 1 Hz. Therefore, the resistance of the specimen in the film thickness direction was obtained, and the ion conductivity was calculated and obtained from Expression (I).

Ion conductivity(mS/cm)=1000×specimen film thickness(cm)/(resistance (Ω)×specimen area(cm²)) Expression (I)

<Evaluation of Slurry Dispersibility>

The viscosity of the solid electrolyte composition obtained above was measured using a 70 rpm B-type viscometer (manufactured by Tokyo Keiki Inc.) within five minutes from the preparation of the solid electrolyte composition and was considered as η₀. The measurement temperature was set to 25° C. The solid electrolyte composition was held at room temperature (approximately 25° C.) for one hour, and the viscosity η₁ was computed using the 70 rpm B-type viscometer after the holding. The measurement temperature was also set to 25° C. The viscosity change percentage Δη(%)=η₁/η₀×100 was computed and evaluated using the following standards. As the numerical values increase, the dispersion stability becomes superior.

5: Δη is 80% or more and less than 120%

4: Δη is 70% or more and less than 80% or 120% or more and less than 130%

3: Δη is 60% or more and less than 70% or 130% or more and less than 140%

2: Δη is 40% or more and less than 60% or 140% or more and less than 160%

1: Δη is less than 40% and 160% or more

<Evaluation of Bonding Properties>

The solid electrolyte sheet or the positive electrode sheet for a secondary battery was cut into a size of 2 cm×10 cm. The collector-side surface of this sheet was wound around SUS sticks having different diameters along the longitudinal direction, the absence or presence of peeling was observed, and the bonding properties were evaluated using the diameters of SUS sticks on which peeling occurred (FIG. 3).

5: Less than 10 mm

4: 10 mm or more and less than 20 mm

3: 20 mm or more and less than 40 mm

2: 40 mm or more and less than 100 mm

1: 100 mm or more

TABLE 3

| | | | Bonding | Ion conductivity |
|---|---|---|---|---|
| No. | Electrolyte layer | Dispersibility | properties | (mS/cm) |
| 101 | S-1 | 5 | 3 | 0.3 |
| 102 | S-2 | 4 | 2 | 0.27 |
| 103 | S-3 | 5 | 4 | 0.38 |
| 104 | S-4 | 5 | 4 | 0.41 |
| 105 | S-5 | 2 | 3 | 0.3 |
| 106 | S-6 | 4 | 4 | 0.31 |
| 107 | S-7 | 5 | 5 | 0.43 |
| 108 | S-8 | 4 | 4 | 0.38 |
| 109 | S-9 | 3 | 4 | 0.32 |
| 110 | S-10 | 5 | 5 | 0.46 |
| 111 | S-11 | 3 | 4 | 0.35 |
| 112 | S-12 | 4 | 4 | 0.36 |
| c11 | T-1 | 1 | 1 | 0.18 |
| c12 | T-2 | 1 | 1 | 0.15 |
| c13 | T-3 | 1 | 2 | 0.13 |
| s11 | T-s1 | 1 | 2 | 0.12 |

### Example 2

### Preparation of Composition for Secondary Battery Positive Electrode

(1) Preparation of Composition for Positive Electrode (U-1)

180 zirconia beads having a diameter of 5 mm were injected into a 45 mL zirconia container (manufactured by Fritsch Japan Co., Ltd.), Li/P/S (2.7 g), individual resins (B-1 and the like) (0.3 g in terms of the solid content), and individual dispersion media (heptane and the like) (22 g) as a dispersion medium were injected thereinto. After that, the container was set in a planetary ball mill P-7 (trade name) manufactured by Fritsch Japan Co., Ltd., and the components were continuously stirred at a temperature of 25° C. and a rotation speed of 300 rpm for two hours. After that, NMC (Nippon Chemical Industrial Co., Ltd.) (7.0 g) was injected thereinto as an active material, similarly, the container was set in a planetary ball mill P-7, and the components were stirred at 25° C. and a rotation speed of 100 rpm for 15 minutes, thereby obtaining individual positive electrode compositions.

(2) Preparation of Positive Electrode Compositions (U-2) to (U-10), (V-1) to (V-3), and (V-s1)

Positive electrode compositions (U-2) to (U-10), (V-1) to (V-3), and (V-s1) were prepared in the same manner as the positive electrode composition (U-1) except for the fact that changes were made as shown in Table 4 in the preparation of the positive electrode composition (U-1).

In the table, blank cells indicate that the dispersion medium was not used.

TABLE 4

| | Positive electrode | | Solid | | | | |
|---|---|---|---|---|---|---|---|
| | active material | | electrolyte | | Binder | | Dispersion |
| Composition | | % | | % | | % | medium |
| U-1 | NMC | 70 | Li/P/S | 27 | B-1 | 3 | Heptane |
| U-2 | NMC | 70 | Li/P/S | 27 | B-2 | 3 | Heptane |
| U-3 | NMC | 70 | Li/P/S | 27 | B-3 | 3 | Heptane |
| U-4 | LCO | 70 | Li/P/S | 27 | B-3 | 3 | Heptane |
| U-5 | NMC | 70 | Li/P/S | 27 | B-3 | 3 | MEK |
| U-6 | NMC | 70 | Li/P/S | 27 | B-4 | 3 | Heptane |
| U-7 | NMC | 70 | Li/P/S | 27 | B-5 | 3 | Heptane |
| U-8 | NMC | 70 | Li/P/S | 27 | B-6 | 3 | Heptane |
| U-9 | NMC | 70 | Li/P/S | 27 | B-8 | 3 | Heptane |
| U-10 | NMC | 70 | Li/P/S | 27 | B-9 | 3 | Heptane |
| V-1 | NMC | 70 | Li/P/S | 27 | PTFE | 3 | |
| V-2 | NMC | 70 | Li/P/S | 27 | BC-1 | 3 | Toluene |
| V-3 | NMC | 70 | Li/P/S | 27 | HBR | 3 | Heptane |
| V-s1 | NMC | 70 | LLZ | 27 | B-2 | 3 | Heptane |

<Note in the table>
Amount blended: Based on mass
LCO: LiCoO₂ lithium cobalt oxide
NMC: Li(Ni_{1/3}Mn_{1/3}Co_{1/3})O₂ nickel, manganese, lithium cobalt oxide

Production of Positive Electrode Sheet for Secondary Battery

Each of the compositions for secondary battery positive electrode (U-1 and the like) obtained above was applied onto a 20 μm-thick aluminum foil using an applicator having an arbitrary clearance, heated at 80° C. for one hour, furthermore, heated at 120° C. for one hour, and a coating solvent was dried. After that, the composition was heated and pressurized using a heat press machine so as to obtain an arbitrary density, thereby obtaining a positive electrode sheet for a secondary battery.

Production of Electrode Sheet for Secondary Battery

Each of the solid electrolyte compositions (S-1 and the like) obtained above was applied onto the positive electrode for a secondary battery obtained above using an applicator having an arbitrary clearance, heated at 80° C. for one hour, and furthermore, heated at 120° C. for one hour. After that, the composition was heated and pressurized using a heat press machine so as to obtain an arbitrary density, thereby manufacturing an electrode sheet for a secondary battery. The film thickness of the positive electrode layer was 80 μm, and the film thickness of the electrolyte layer was 30 m.

Production of all Solid State Secondary Battery

A disc-shaped piece having a diameter of 14.5 mm was cut out from the electrode sheet for a secondary battery obtained above, put into a 2032-type stainless steel coin case into which a spacer and a washer were combined, and an indium foil cut out into 15 mmφ was overlaid on the solid electrolyte (SE) layer. A stainless steel foil was further overlaid thereon, and the coin case was swaged, thereby producing an all solid state secondary battery (regarding the test specimen, refer to FIG. 2).

<Evaluation of Discharge Capacity Retention>

The all solid state secondary battery obtained above was evaluated using a charging and discharging evaluation device TOSCAT-3000 (trade name) manufactured by Toyo System Co., Ltd. Charging was carried out at a current density of 0.2 mA/cm² until the battery voltage reached 3.6 V, and, after the battery voltage reached 3.6 V, constant-voltage charging was carried out until the current density reached less than 0.02 mA/cm². Discharging was carried out at a current density of 0.2 mA/cm² until the battery voltage reached 2.5 V. This charging and discharging was repeated three times under the above-described conditions, and initialization was carried out. The discharge capacity at the first cycle after the initialization was set to 100%, and the number of cycles at which the discharge capacity retention reached 80% was evaluated using the following standards.

A: 100 Cycles or more

B: 50 Cycles or more and less than 100 cycles

C: 20 Cycles or more and less than 50 cycles

D: Less than 20 cycles

E: Charging and discharging is not possible

<Evaluation of Resistance>

The all solid state secondary battery obtained above was evaluated using a charging and discharging evaluation device TOSCAT-3000 manufactured by Toyo System Co., Ltd. Charging was carried out at a current density of 0.2 mA/cm² until the battery voltage reached 3.6 V, and, after the battery voltage reached 3.6 V, constant-voltage charging was carried out until the current density reached less than 0.02 mA/cm². Discharging was carried out at a current density of 0.2 mA/cm² until the battery voltage reached 2.0 V. This charging and discharging was repeated, the battery voltage after the discharge of 5 mAh/g (the amount of electricity per gram of the active material mass) at the third cycle was read using the following standards, and the resistance was evaluated. An increase in the battery voltage indicates low resistances.

A: 3.4 V or more

B: 3.2 V or more and less than 3.4 V

C: 3.0 V or more and less than 3.2 V

D: Less than 3.0 V

E: Charging and discharging is not possible

<Evaluation of Cycle Characteristics>

The all solid state secondary battery obtained above was evaluated using a charging and discharging evaluation device TOSCAT-3000 (trade name) manufactured by Toyo System Co., Ltd. Charging was carried out at a current density of 0.2 mA/cm² until the battery voltage reached 3.6 V, and, after the battery voltage reached 3.6 V, constant-voltage charging was carried out until the current density reached less than 0.02 mA/cm². Discharging was carried out at a current density of 0.2 mA/cm² until the battery voltage reached 2.5 V. Three cycles of charging and discharging were repeated under the above-described conditions, thereby initializing the all solid state secondary battery. The discharge capacity at the first cycle after the initialization was set to 100%, and the discharge capacity retentions after the repetition of 20 cycles of charging and discharging were evaluated using the following standards.

A: 96% or more

B: 93% or more and less than 96%

C: 90% or more and less than 93%

D: 1% or more and less than 90%

E: Cannot be charged and discharged

Meanwhile, Tests c21 to c23 in Table 6 below are comparative examples. In addition, s21 is a reference example (comparative example) in which an electrolyte not including a sulfur atom was used as the solid electrolyte.

TABLE 5

| | Cell constitution | | | |
|---|---|---|---|---|
| | Positive | | | Discharge |
| No. | electrode layer | Electrolyte layer | Resistance | capacity retention |
| 201 | U-1 | S-1 | B | B |
| 202 | U-2 | S-2 | B | C |
| 203 | U-3 | S-3 | A | B |
| 204 | U-4 | S-3 | A | B |
| 205 | U-5 | S-3 | C | C |
| 206 | U-6 | S-6 | C | B |
| 207 | U-7 | S-7 | A | A |
| 208 | U-8 | S-8 | B | B |
| 209 | U-9 | S-10 | A | A |
| 210 | U-10 | S-12 | B | B |
| c21 | V-1 | T-1 | D | D |
| c22 | V-2 | T-2 | D | D |
| c23 | V-3 | T-3 | D | D |
| s21 | V-s1 | T-3 | E | E |

### Example 3

Individual resins were synthesized by changing or subtracting the proportion of A-4 (Formulation α) introduced into Macromonomer M-1 or substituting part or all of A-4 with A-1 or A-30. Electrode sheets and secondary batteries were produced using these resins instead of B-1, and experiments were carried out in the same manner as Tests 101 and 201. As a result, it was confirmed that, for all of the macromonomers, favorable performance was exhibited in all of the items described above.

### Example 4

Macromonomers were synthesized using individual monomers described below instead of MM-2 (Formulation α) introduced into Macromonomer M-1. Electrode sheets and secondary batteries were produced using these macromonomers, M-2, and M-3, and experiments were carried out in the same manner as Tests 101 and 201. As a result, it was confirmed that, for all of the macromonomers, favorable performance was exhibited in all of the items described above.

Meanwhile, n2 in Macromonomer MM-10 represents 10≦n2≦200.

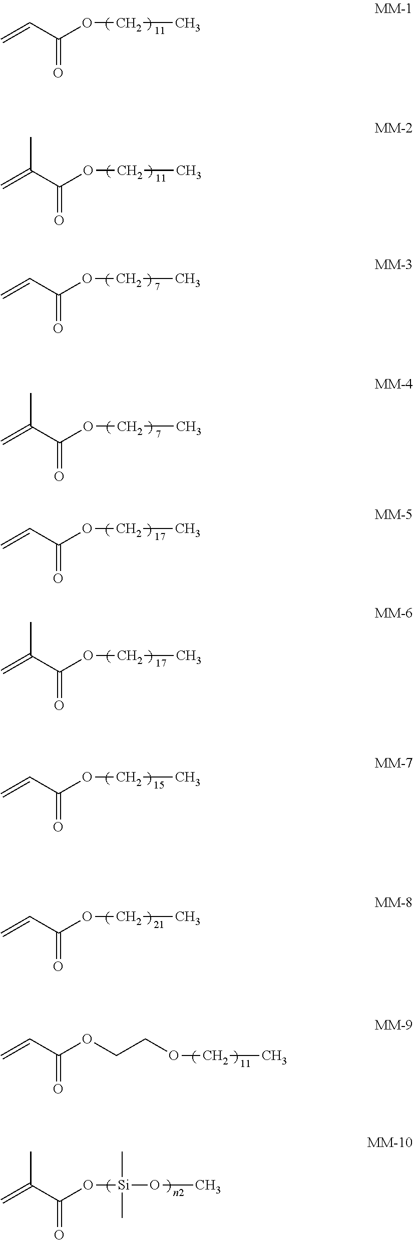

### Example 5

Individual resins (high-molecular-weight compounds forming the binder) were synthesized using A-31, A-37, A-61, A-65, and A-72 instead of M2 (A-4) used as a monomer forming the main chain in the synthesis of Resin B-1. In addition, individual resins were synthesized using A-22, A-25, A-26, A-30, A-50, A-53, A-57, A-60, A-62, and A-78 instead of A-1 of Resin B-5. Electrode sheets and secondary batteries were produced using these resins, and experiments were carried out in the same manner as Tests 101 and 201. As a result, it was confirmed that, for all of the resins, favorable performance was exhibited in all of the items described above.

### Example 6

Individual resins (high-molecular-weight compounds forming binders) were synthesized in the same manner except for the fact that Li/P/S (Li₂S—P₂S₅) used in Test 101 was changed to Li₂S—LiI—Li₂O—P₂S₅, Li₂S—Li₃PO₄—P₂S₅, and Li₁₀GeP₂S₁₂. Electrode sheets and secondary batteries were produced using these resins, and experiments were carried out in the same manner as Tests 101 and 201. As a result, it was confirmed that, for all of the resins, favorable performance was exhibited in all of the items described above.

<Measurement of Particle Diameters>

(Measurement of Average Particle Diameter of Binder)

The average particle diameter of the binder particles was measured in the following order.

A dispersion liquid (1% by mass) of the binder prepared above was diluted and adjusted using an arbitrary solvent (the dispersion medium used in the preparation of the solid electrolyte composition; in the case of Binder B-1, heptane) in a 20 ml sample bottle. The diluted dispersion liquid specimen was irradiated with 1 kHz ultrasonic waves for ten minutes and immediately used for tests. Data acquisition was carried out 50 times using this dispersion liquid specimen, a laser diffraction/scattering particle size analyzer LA-920 (manufactured by Horiba Ltd.), and a silica cell for measurement at a temperature of 25° C., and the obtained volume-average particle diameter was used as the average particle diameter. Regarding other detailed conditions, the description of JIS Z8828:2013 “Particle diameter analysis-dynamic light scattering method” was referred to as necessary. Five specimens were produced each level, and the average value thereof was employed.

(Measurement of Average Particle Diameter of Inorganic (Solid Electrolyte) Particles)

The average particle diameter of the inorganic (solid electrolyte) particles was measured in the following order.

A dispersion liquid (1% by mass) of inorganic particles was diluted and adjusted using water (in the case of a substance unstable in water, heptane) in a 20 ml sample bottle. The diluted dispersion liquid specimen was irradiated with 1 kHz ultrasonic waves for ten minutes and immediately used for tests. Data acquisition was carried out 50 times using this dispersion liquid specimen, a laser diffraction/scattering particle size analyzer LA-920 (manufactured by Horiba Ltd.), and a silica cell for measurement at a temperature of 25° C., and the obtained volume-average particle diameter was used as the average particle diameter. Regarding other detailed conditions, the description of JIS Z8828:2013 “Particle diameter analysis-dynamic light scattering method” was referred to as necessary. Five specimens were produced each level, and the average value thereof was employed.

<Method for Measuring Glass Transition Temperature (Tg)>

The glass transition temperature (Tg) was measured using the dried specimen and a differential scanning calorimeter (manufactured by SII-NanoTechnology Inc., DSC7000) under the following conditions. The glass transition temperature of the same specimen is measured twice, and the measurement result of the second measurement is used.

Atmosphere of the measurement chamber: nitrogen (50 mL/min)
Temperature-increase rate: 5° C./min
Measurement-start temperature: −100° C.
Measurement-end temperature: 200° C.
Specimen plate: aluminum plate
Mass of the measurement specimen: 5 mg

Estimation of Tg: The middle temperature between the declination-start point and the declination-end point in the DSC chart is considered as Tg.

The present invention has been described together with the embodiment; however, unless particularly specified, the present inventors do not intend to limit the present invention in any detailed portion of the description and consider that the present invention is supposed to be broadly interpreted within the concept and scope of the present invention described in the claims.

### EXPLANATION OF REFERENCES

1: negative electrode collector
2: negative electrode active material layer
3: solid electrolyte layer
4: positive electrode active material layer
5: positive electrode collector
6: operation portion
10: all solid state secondary battery
11: coin case
12: sheet (solid electrolyte sheet or electrode sheet for secondary battery)
13: coin battery
S: screw
21: SUS stick cross-section
31: solid electrolyte layer or electrode layer

What is claimed is:

1. A solid electrolyte composition comprising:
an inorganic solid electrolyte;
binder particles; and
a dispersion medium,
wherein the inorganic solid electrolyte has a conductivity of ions of metals belonging to Group I or II of the periodic table and includes a sulfur atom, and
the binder particles are constituted of a polymer having a macromonomer having a mass average molecular weight of 1,000 or more combined therewith as a side chain component and having at least one group from a group of functional groups (b) below,
group of functional groups (b): a carboxyl group, a sulfonic acid group, a phosphoric acid group, and a phosphonic acid group.

2. The solid electrolyte composition according to claim 1,
wherein a polymer constituting the binder particles has a carboxyl group.

3. The solid electrolyte composition according to claim 1,
wherein the polymer constituting the binder particles is a carboxyl group-containing polymer, and
the carboxyl group-containing polymer contains 0.1% to 10% by mass of a repeating unit having a carboxyl group.

4. The solid electrolyte composition according to claim 1,
wherein the polymer constituting the binder particles includes a repeating unit derived from a monomer selected from (meth)acrylic acid monomers, (meth)acrylic acid ester monomers, and (meth)acrylonitrile.

5. The solid electrolyte composition according to claim 1,
wherein an average particle diameter of the binder particles is 10 nm or more and 1,000 nm or less.

6. The solid electrolyte composition according to claim 1,
wherein the average particle diameter of the binder particles is 300 nm or less.

7. The solid electrolyte composition according to claim 1,
wherein a proportion of a repeating unit derived from the macromonomer in the polymer constituting the binder particles is 1% by mass or more and 50% by mass or less.

8. The solid electrolyte composition according to claim 1,
wherein the inorganic solid electrolyte is represented by Formula (1),
LₐM_{b}P_{c}S_{d}Aₑ Formula (1)
(in the formula, L represents an element selected from Li, Na, and K, M represents an element selected from B, Zn, Sn, Si, Cu, Ga, Sb, Al, and Ge, A represents I, Br, Cl, or F, a to e represent compositional ratios of individual elements, and a:b:c:d:e satisfies 1 to 12:0 to 1:1:2 to 12:0 to 5).

9. The solid electrolyte composition according to claim 8,
wherein L in the inorganic solid electrolyte is Li.

10. The solid electrolyte composition according to claim 1,
wherein an SP value of the macromonomer is 10 or less.

11. The solid electrolyte composition according to claim 1,
wherein a glass transition temperature of the polymer constituting the binder particles is 130° C. or lower.

12. The solid electrolyte composition according to claim 1,
wherein the inorganic solid electrolyte is represented by Formula (2),
LiₗPₘSₙ Formula (2)
in the formula, 1 to n represent compositional ratios of individual elements, and l:m:n satisfies 2 to 4:1:3 to 10.

13. The solid electrolyte composition according to claim 1,
wherein the macromonomer includes a polymerizable double bond and a hydrocarbon structural unit having 6 or more carbon atoms.

14. The solid electrolyte composition according to claim 1,
wherein the macromonomer is a compound represented by any one of Formulae (N-1) to (N-3), 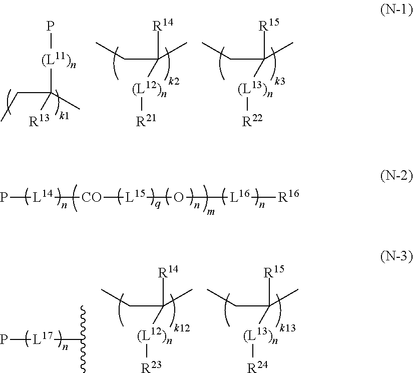
P represents a polymerizable group, L¹¹ to L¹⁷ each independently represent a linking group, k1, k2, k3, k12, and k13 represent the molar fractions, m represents an integer of 1 to 200, n represents 0 or 1, R¹³ to R¹, R²¹, and R²³ each independently represent a polymerizable group, a hydrogen atom, a hydroxyl group, a cyano group, a halogen atom, a carboxyl group, an alkyl group, an alkenyl group, an alkynyl group, or an aryl group, R¹⁶ represents a hydrogen atom or a substituent, q represents 0 or 1, R²² represents a chain-like structural portion having a higher molecular weight than R²¹, and R²⁴ represents a hydrogen atom or a substituent.

15. The solid electrolyte composition according to claim 1, further comprising:
an active material capable of intercalating and deintercalating ions of metals belonging to Group I or II of the periodic table.

16. The solid electrolyte composition according to claim 1,
wherein a content of the binder particles is 0.1 parts by mass or more and 20 parts by mass or less with respect to 100 parts by mass of the inorganic solid electrolyte.

17. The solid electrolyte composition according to claim 1,
wherein the dispersion medium is selected from an alcohol compound solvent, an ether compound solvent, an amide compound solvent, a ketone compound solvent, an aromatic compound solvent, an aliphatic compound solvent, and a nitrile compound solvent.

18. An electrode sheet for a battery,
wherein a film of the solid electrolyte composition according to claim 1 is formed on a metal foil.

19. An all solid state secondary battery comprising:
a positive electrode active material layer;
a negative electrode active material layer; and
a solid electrolyte layer,
wherein at least one of the positive electrode active material layer, the negative electrode active material layer, or the solid electrolyte layer is a layer constituted of the solid electrolyte composition according to claim 1.

20. A method for manufacturing an electrode sheet for a battery, comprising:
disposing the solid electrolyte composition according to claim 1 on a metal foil; and
producing a film of the solid electrolyte composition.

21. A method for manufacturing an all solid state secondary battery,
wherein an all solid state secondary battery is manufactured using the manufacturing method according to claim 20.
